(19) United States
(12) Patent Application Publication
(10) Pub. No.: US 2025/0341627 A1
(43) Pub. Date: Nov. 6, 2025

(54) Two-Way Time Transfer and Ranging Using a Communication Link

(71) Applicant: THE AEROSPACE CORPORATION, El Segundo, CA (US)

(72) Inventors: Daniel HAAS, Glendale, CA (US); Lee A. KENYON, Torrance, CA (US)

(73) Assignee: THE AEROSPACE CORPORATION, El Segundo, CA (US)

(21) Appl. No.: 18/656,084

(22) Filed: May 6, 2024

(51) Int. Cl. G01S 13/46; G01S 5/00; H04W 64/00

(52) U.S. Cl. CPC G01S 13/46; G01S 5/0063; H04W 64/006

(57) ABSTRACT

Some examples estimate time-varying range and clock offset between first and second transceivers that are moving relative to one another. The first transceiver transmits a first stream of symbols at a first succession of times according to a first clock, and receives from the second transceiver a second stream of symbols transmitted at a second succession of times according to a second clock. The first transceiver estimates arrival times and delays of symbols of the received second stream of symbols, and uses them to calculate first and second values describing a relationship between the estimated arrival times and delays of symbols. The first transceiver receives from the second transceiver third and fourth values describing a relationship between estimated arrival times and delays of symbols of the first stream of symbols. The first transceiver estimates the time-varying range and time-varying clock offset using the first, second, third, and fourth values.

### STATEMENT OF GOVERNMENT INTEREST

This invention was made with government support under Contract No. FA8802-19-C-0001 awarded by the Department of the Air Force. The government has certain rights in the invention.

### FIELD

This application generally relates to two-way time transfer and ranging.

### BACKGROUND

Two-way time transfer and ranging (TWTTR) includes simultaneous clock synchronization and ranging between two or more transceivers. A collection of transceivers, separated by possibly a large distance (for example, even on opposite sides of the earth), are to have their relative ranges determined and simultaneously have their clocks synchronized via signals sent strictly between the transceivers with no outside help. For example, if the clocks synchronized to a common global positioning system (GPS) signal, they could synchronize, but it would not fall under the nomenclature of “two-way time transfer”. It would be useful to have the capacity for range determination and clock synchronization even when GPS signals or supporting ground processing are not available. The term “time transfer” may be thought of as “transferring” the time of one clock to the other via signals sent among them, but more generally relates to clock synchronization.

Systems may need to achieve clock synchronization or range determination for a variety of reasons. The most well-known example is GPS. For example, to enable a receiver on earth to determine its location and synchronize its clock with GPS time, the GPS satellites may need to have their clocks highly synchronized and their varying ephemerides accurately determined. GPS satellites achieve zero-day clock synchronization to the order of 0.1 to 1 nanoseconds and zero-day weighted ephemeride estimates to an accuracy of 10 to 20 centimeters. Another example is a very large array of radio telescopes exploring the universe, for which accurate direction finding may benefit from sufficiently accurate array element ranging and clock synchronization.

Legacy systems commonly use ranging codes for time transfer and/or ranging. For example, the United States' Satellite Control Network computes ranging between ground stations and space assets by measuring the round trip delay of a ranging code transmitted up to a space asset and back down to the ground station. Some legacy systems use two-way time transfer techniques, sending ranging codes in both directions and measuring one way signal propagation delays. This enables achieving both ranging and clock synchronization. An example of a system that implements such a scheme is the legacy GPS constellation. With either approach, the use of a ranging code comes at a cost of bandwidth, power, and time resources.

### SUMMARY

Examples herein provide two-way time transfer and ranging using a communication link.

In some examples, a method is provided for estimating a time-varying range and time-varying clock offset between a first transceiver having a first clock and a second transceiver having a second clock. The first and second transceivers may be moving relative to one another. The method may include, by the first transceiver, transmitting to the second transceiver a first stream of symbols at a first succession of times according to the first clock. The method may include, by the first transceiver, receiving from the second transceiver a second stream of symbols which the second transceiver transmits at a second succession of times according to the second clock. The method may include, by the first transceiver, estimating arrival times and delays of symbols of the received second stream of symbols. The method may include, by the first transceiver, using the estimated arrival times and delays to calculate a first value and a second value describing a relationship between the estimated arrival times and delays of symbols of the received second stream of symbols. The method may include, by the first transceiver, receiving from the second transceiver a third value and a fourth value describing a relationship between estimated arrival times and delays of symbols of the first stream of symbols transmitted to the second transceiver. The method may include, by the first transceiver, estimating the time-varying range and time-varying clock offset using the first, second, third, and fourth values.

In some examples, the first succession of times includes a first symbol at a first known time and a first plurality of additional symbols at a first known symbol rate, and the second succession of times includes a second symbol at a second known time and a second plurality of additional symbols at a second known symbol rate.

In some examples, the first known time and the second known time are a priori known to both the first transceiver and the second transceiver.

In some examples, the first stream of signals communicates the first known time to the second transceiver, and the second stream of signals communicates the second known time to the first transceiver.

In some examples, the relationship between the estimated arrival times and delays of symbols of the received second stream of symbols includes a first best-fit straight line through those estimated delays as a function of those estimated arrival times. In some examples, the first value includes a slope (s_{A}) of the first best-fit straight line, and wherein the second value includes a y-intercept (y_{A}) of the first best-fit straight line. In some examples, the relationship between the estimated arrival times and delays of symbols of the first stream of symbols transmitted to the second transceiver includes a second best-fit straight line through those estimated delays as a function of those estimated arrival times. In some examples, the third value includes a slope (s_{B}) of the second best-fit straight line, and the fourth value includes a y-intercept (y_{B}) of the second best-fit straight line. In some examples, the first transceiver estimates the time-varying range and clock offset using:

$$β = \frac{- y - \sqrt{{y}^{2} - 4 xz}}{2 x} , \\ b = \frac{( {s}_{A} - β ) {k}_{B}}{1 - β} , \\ a = \frac{{y}_{B} - {y}_{A} \frac{( b / {k}_{A} ) - 1}{1 - β}}{\frac{1}{{k}_{A}} - \frac{( b / {k}_{A} ) - 1}{{k}_{B}}} , \\ α = {y}_{A} - \frac{a ( 1 - β )}{{k}_{B}} ,$$

wherein:
   c is the speed of light;
   k_{A} and k_{B} are constants;
   α is the time-varying clock offset;
   β is a rate of change of the time-varying clock offset;
   ca is the estimated time-varying range;
   cb is the estimated time-varying velocity; and

$$x {=}^{def} 1 - {s}_{B} , \\ y {=}^{def} {k}_{A} {s}_{B} - {k}_{B} - ( 1 - {s}_{B} ) {k}_{A} , \\ z {=}^{def} {s}_{A} {k}_{B} - {k}_{A} {s}_{B} .$$

In some examples, the method further includes, by the first transceiver, transmitting the first value and the second value to the second transceiver. In some examples, the method further includes, by the second transceiver, transmitting to the first transceiver the second stream of symbols at the second succession of times according to the second clock. In some examples, the method further includes, by the second transceiver, receiving from the first transceiver the first stream of symbols. In some examples, the method further includes, by the second transceiver, estimating arrival times and delays of symbols of the received first stream of symbols. In some examples, the method further includes, by the second transceiver, using the estimated arrival times and delays to calculate the third value and the fourth value. In some examples, the method further includes, by the second transceiver, transmitting to the first transceiver the third value and the fourth value describing a relationship between estimated arrival times and delays of symbols of the first stream of symbols transmitted to the second transceiver. In some examples, the method further includes, by the second transceiver, receiving from the first transceiver the first value and the second value. In some examples, the method further includes, by the second transceiver, estimating the time-varying range and time-varying clock offset using the first, second, third, and fourth values.

In some examples, the first transceiver further uses a Kalman filter to estimate, or to average an estimate of, at least one of: the time-varying range, time-varying velocity, time-varying clock offset, and time varying clock rate offset.

In some examples, the first transceiver is located on a first satellite or is terrestrial, and wherein the second transceiver is located on a second satellite or is terrestrial.

In some examples, the method further includes using the time-varying clock offset to synchronize the first clock to the second clock.

In some examples, the first stream of symbols is superimposed on a first carrier, the second stream of symbols is superimposed on a second carrier, and the method further includes, by the first transceiver, estimating at least one of (i) a clock rate offset and (ii) a Doppler shift, using a frequency offset of the first carrier or a frequency offset of the second carrier.

In some examples, generating the first, second, third, and fourth values is performed iteratively.

Some examples herein provide a first transceiver which is moving relative to a second transceiver. The first transceiver may include a first clock; an antenna; a processor; and non-volatile computer-readable memory storing operations. The operations may cause the processor to transmit to the second transceiver, via the antenna, a first stream of symbols at a first succession of times according to the first clock. The operations may cause the processor to receive from the second transceiver, via the antenna, a second stream of symbols which the second transceiver transmits at a second succession of times according to a second clock of the second transceiver. The operations may cause the processor to estimate arrival times and delays of symbols of the received second stream of symbols. The operations may cause the processor to use the estimated arrival times and delays to calculate a first value and a second value describing a relationship between the estimated arrival times and delays of symbols of the received second stream of symbols. The operations may cause the processor to receive from the second transceiver, via the antenna, a third value and a fourth value describing a relationship between estimated arrival times and delays of symbols of the first stream of symbols transmitted to the second transceiver. The operations may cause the processor to estimate the time-varying range and time-varying clock offset using the first, second, third, and fourth values.

Some examples herein provide a system that includes a first transceiver including a first clock and a first antenna; and a second transceiver including a second clock and a second antenna. The first transceiver and the second transceiver may be moving relative to one another. The first transceiver may be configured to transmit to the second transceiver, via the first antenna, a first stream of symbols at a first succession of times according to the first clock. The second transceiver may be configured to transmit to the first transceiver, via the second antenna, a second stream of symbols at a second succession of times according to the second clock. The first transceiver may be configured to receive the second stream of symbols from the second transceiver, via the first antenna. The first transceiver may be configured to estimate arrival times and delays of symbols of the received second stream of symbols. The first transceiver may be configured to use the estimated arrival times and delays to calculate a first value and a second value describing a relationship between the estimated arrival times and delays of symbols of the received second stream of symbols. The second transceiver may be configured to receive the first stream of symbols from the first transceiver, via the second antenna. The second transceiver may be configured to estimate arrival times and delays of symbols of the received first stream of symbols. The second transceiver may be configured to use the estimated arrival times and delays to calculate a third value and a fourth value describing a relationship between the estimated arrival times and delays of symbols of the received first stream of symbols. The second transceiver may be configured to transmit the third value and the fourth value to the first transceiver, via the second antenna. The first transceiver may be configured to: receive from the second transceiver, via the antenna, the third value and the fourth value; and estimate a time-varying range and a time-varying clock offset between the first transceiver and the second transceiver using the first, second, third, and fourth values.

In some examples, the first transceiver is configured to transmit the first value and the second value to the second transceiver, via the first antenna. In some examples, the second transceiver is configured to estimate the time-varying range and the time-varying clock offset between the first transceiver and the second transceiver using the first, second, third, and fourth values.

### BRIEF DESCRIPTION OF DRAWINGS

FIG. 1 illustrates two-way time transfer between stationary transceivers.

FIG. 2 illustrates example transceiver motion affecting propagation delay.

FIG. 3 illustrates example signal transmission from one transceiver to another.

FIG. 4 illustrates an example two-way time transfer and ranging architecture.

FIG. 5 illustrate example positioning of transceivers' two-way time transfer windows.

FIGS. 6A-6B illustrate example transceiver processing of symbols arriving during two-way time transfer windows.

FIG. 7 illustrates example Kalman filtering state estimation, full state observability.

FIG. 8 illustrates example Kalman filtering state estimation, partial state observability.

FIG. 9 illustrates example use of two-way time transfer and ranging with an orbit determination Kalman filter.

FIG. 10 illustrates an example flow of operations in a method for estimating a time-varying range and time-varying clock offset between transceivers.

FIG. 11 illustrates orbit information for a simulated medium earth orbit (MEO) scenario.

### DETAILED DESCRIPTION

Examples herein provide two-way time transfer and ranging using a communication link.

### 1. Introduction

The example systems and methods presented in this patent application, which may be referred to as C-TWTTR (Communication Link Based Two Way Time Transfer and Ranging), completely discard ranging codes in preferred embodiments. Rather, the present C-TWTTR uses the built-in capabilities of a digital transceiver to implement two way time transfer and ranging. In a manner such as described herein, the transceiver is configured to do this by using the waveform symbols themselves as ranging and time-synchronization codes. For example, symbol arrival times are provided by the digital transceiver via the built-in symbol tracking loop. Further, the built-in carrier tracking loop of the digital transceiver provides range rate and clock offset rate information that C-TWTTR leverages. Together with an optional Kalman filter architecture, this enables C-TWTTR to achieve substantially improved performance, even for dynamic links with less stable clocks. With sufficient bandwidth, clock synchronization on the order of pico-seconds, and range estimates on the order of millimeters are achieved. Furthermore, the elimination of ranging codes, and use of the built-in processes of a digital transceiver enables C-TWTTR to achieve such performance with more efficient utilization of bandwidth, power, and time resources.

The next section begins with an overview of the basic idea of two-way time transfer and ranging.

### 2. Two Way Time Transfer and Ranging for Static Dynamics

This section presents the basic idea behind two-way time transfer and ranging by considering two transceivers with static dynamics. By “static dynamics” it is meant that the range and clock offset are not varying with time. This simplified scenario is useful for understanding the core idea of two-way time transfer and ranging algorithms. In the next section the algorithm is extended to time varying dynamics—that is, time varying range and time varying clock offset, to which the present application is directed.

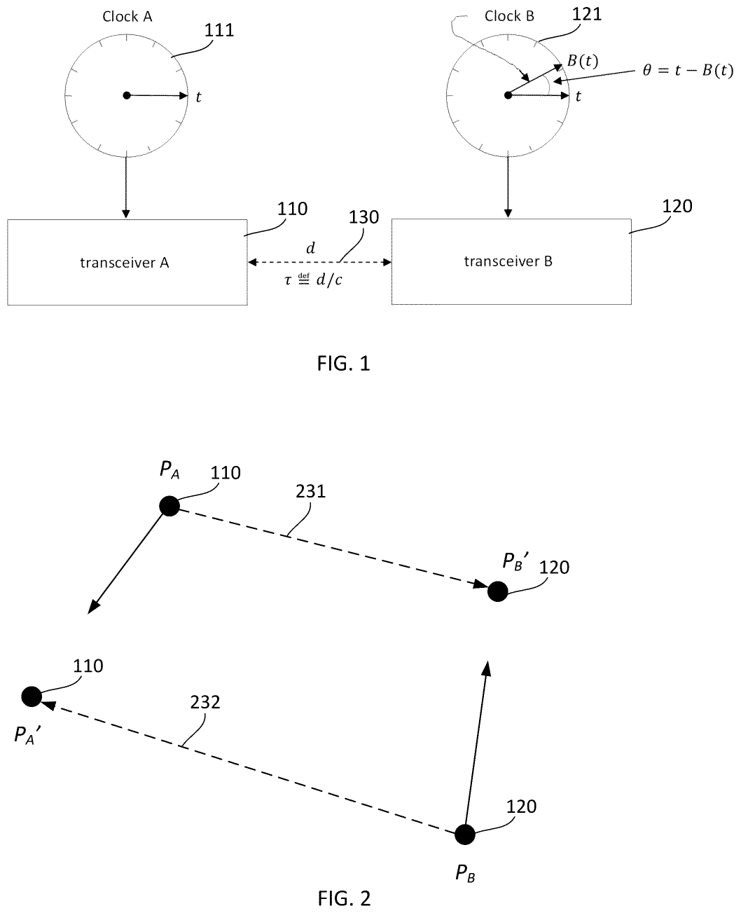

FIG. 1 illustrates two-way time transfer between stationary transceivers, more specifically transceiver A 110 including internal clock A 111, and transceiver B 120 including internal clock B 121. Clock A 111 may be considered as showing the “correct” time, labeled time t (seconds), which may in some cases be referred to as “universal time.” At time t (that is, when clock A 111 shows the time t), clock B shows the time B(t). The clock offset may be expressed as

$$θ ( t ) {=}^{def} t - B ( t ) . \qquad ( 2.1 )$$

Notice that θ(t) is positive when clock B 121 lags clock A 111. Notice also that in this section where static dynamics is assumed, the clock offset θ(t) does not vary with time. That is, θ(t)=θ for some fixed θ. The distance 130 between the transceivers at time t is labeled as d(t)=d (again, in this section not varying with time). The variable t may be expressed as:

$$τ {=}^{def} \frac{d}{c} , , \qquad ( 2.2 )$$

where c=3×10⁸ m/s is the speed of light. The variable t is the propagation delay of a signal transmitted among the transceivers.

In TWTTR, each transceiver 110, 120, when transmitting a signal, stamps the signal with the transmit time according to its own clock 111, 121. So, when transceiver A 110 transmits a first signal at time t, that transceiver stamps the first signal with time t. When transceiver B 120 transmits a second signal at time t, that transceiver stamps the first signal with time B(t), the time shown on its own clock. Likewise, each transceiver, upon receiving the signal sent by the other transceiver, determines the arrival time of the signal according to its own clock. So, if the second signal sent by transceiver B 120 arrives at transceiver A 110 at time t, then transceiver A determines the arrival time of the signal to be time t. But if the first signal that transceiver A 110 transmits arrives at transceiver B 120 at time t, transceiver B determines the arrival time to be B(t).

Each transceiver 110, 120 is configured to form an estimate of the propagation delay of the signal it receives by subtracting from the signal arrival time (as determined with its own clock) the signal transmit time as stamped upon the signal. As such, the following expressions may be established:
τ_{A}(t) [symbol] transceiver A 110's propagation delay estimate for the signal it receives at universal time t (of clock 111), and
τ_{B}(t) [symbol] transceiver B 120's propagation delay estimate for the signal it receives at universal time t.

Transceiver A 110 and transceiver B 120 are configured to then respectively compute τ_{A}(t) and τ_{B}(t) as follows:
τ_{A}(t)=t—the time stamped on the received signal, and
τ_{B}(t)=B(t)—the time stamped on the received signal.

In this example, it is assumed that the two transceivers' delay estimates are perfect. A key observation then may be expressed as:

$${τ}_{A} ( t ) = τ + θ , \\ {τ}_{B} ( t ) = τ - θ . \qquad ( 2.3 )$$

That is, while the propagation delay t affects both delay estimates identically, the clock offset θ affects both delay estimates with opposite sign.

Transceivers 110 and 120 are configured to share their respective delay estimates τ_{A}(t) and τ_{B}(t) with one another, and use these estimates to separate the effect of the propagation delay and clock offset, determining both the propagation delay and clock offset. For example, both transceiver A 110 and transceiver B 120 may determine:

$$τ = \frac{{τ}_{A} + {τ}_{B}}{2} , \qquad ( 2.4 )$$

$$θ = \frac{{τ}_{A} + {τ}_{B}}{2} . \qquad ( 2.5 )$$

In a manner such as provided herein, this concept may be extended to two-way time transfer and ranging algorithms in which the transceivers are moving relative to one another.

### 3. Two Way Time Transfer and Ranging For Time Varying Dynamics

This section explains the more complicated scenario in which the transceivers' relative distance and clock offset are time varying. Again, t is used to express the “correct” time shown by clock A 111 (referred to in some cases as “universal time”), and B(t) is used to express the time shown by clock B 121 at universal time t. The distance 130 between the transceivers at time t may be expressed as d(t) (in meters), and the following relationship may be expressed:

$$τ ( t ) {=}^{def} \frac{d ( t )}{c} , \qquad ( 3.1 )$$

where c=3×10⁸ m/s is the speed of light. Notice that because the transceivers are in motion, τ(t) no longer exactly expresses the propagation delay of a signal sent at time t as it did in the static case. For example, consider FIG. 2 which illustrates example transceiver motion affecting propagation delay. More specifically, transceiver A 110 and transceiver B 120 respectively are at positions P_{A} and P_{B} at time t when transceiver A transmits a first signal 231 to transceiver B, and transceiver B transmits a second signal 232 to transceiver A. Due to the transceivers' respective velocities, while the signal is propagating, transceiver A moves to point P_{A}′ and transceiver B moves to point P_{B}′. The result is that the signal 231 from transceiver A 110 to transceiver B 120 traverses the path P_{A}→P_{B}′, and the signal 232 from transceiver B to transceiver A traverses the path P_{B}→P_{A}′. These two paths have lengths different than d(t) which is the distance 130 between P_{A} and P_{B} in the static example described with reference to FIG. 1. Indeed, the paths of signals 231 and 232 have different lengths from one another, as may be seen in FIG. 2. In particular, τ=d(t)/c is no longer the propagation time for either signal, as was the case in FIG. 1. Instead, the delay may be expressed as a function of t (t) in a manner such as will be explained.

The propagation delays of signals 231 and 232 respectively may be expressed as:
τ_{AB}(t)=the true propagation delay of signal 231 transmitted from transceiver A 110 to transceiver B 120 and arriving at transceiver B at universal time t, and
τ_{BA}(t)=the true propagation delay of signal 232 transmitted from transceiver B 120 to transceiver A 110 and arriving at transceiver A at universal time t.

As provided herein, τ_{AB}(t) and τ_{BA}(t) may be related to τ(t). In particular, with velocities measured in the earth centered inertial (ECI) coordinate frame, the following expressions may be used:

$${v}_{A} ( t ) = the radial velocity of transceiver A 110 away from transceiver B at time t , \qquad ( 3.2 )$$

$${v}_{A}^{⊥} ( t ) = the velocity at time t of transceiver A in the plane perpendicular to radial line connecting A and B , \qquad ( 3.3 )$$

$${v}_{B} ( t ) = the radial velocity of transceiver B away from transceiver A at time t , \qquad ( 3.4 )$$

$${v}_{B}^{⊥} ( t ) = the velocity at time t of transceiver B in the plane perpendicular to radial line connecting A and B . \qquad ( 3.5 )$$

Positive velocities correspond to increasing radial distance. Writing c for the speed of light, Lemma 1 may be obtained:

$${τ}_{AB} ( t ) = \frac{τ ( t )}{\sqrt{{( 1 + \frac{{v}_{A} ( t )}{c} )}^{2} + {( \frac{{v}_{A}^{⊥} ( t )}{c} )}^{2}}} , \qquad ( 3.6 )$$

$${τ}_{BA} ( t ) = \frac{τ ( t )}{\sqrt{{( 1 + \frac{{v}_{B} ( t )}{c} )}^{2} + {( \frac{{v}_{B}^{⊥} ( t )}{c} )}^{2}}} . \qquad ( 3.7 )$$

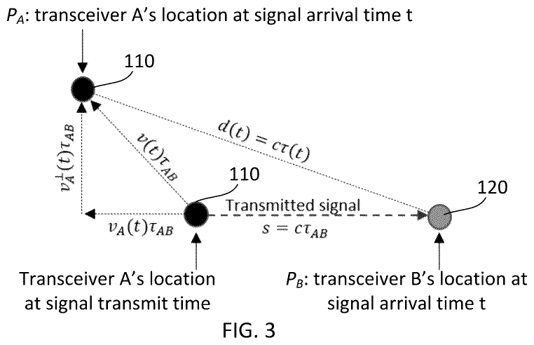

For example, consider a signal transmission from transceiver A 110 to transceiver B 120 with the signal arriving at transceiver B at universal time t. As illustrated in FIG. 2, at time t, transceiver A 110 is at position P_{A} and transceiver B 120 is at position P_{B}. As illustrated in FIG. 3, which illustrates example signal transmission from one transceiver to another, transceiver A 110 travels with velocity vector \vec{v}(t) and speed v(t), and is traveling away from transceiver B 12—with radial speed v_{A}(t) and perpendicular speed

$${v}_{A}^{⊥} ( t ) .$$

At time t, the distance between the transceivers may be expressed as d(t)=cτ(t). Additionally, the propagation distance may be expressed as s=cτ_{AB}(t). The following then may be expressed:

$$\begin{matrix}{d}^{2} = {c}^{2} {τ}^{2} & ( 3.8 ) \\ = {( s + {v}_{A} ( t ) {τ}_{AB} )}^{2} + {( {v}_{A}^{⊥} ( t ) {τ}_{AB} )}^{2} & ( 3.9 ) \\ = {( c {τ}_{AB} + {v}_{A} ( t ) {τ}_{AB} )}^{2} + {( {v}_{A}^{⊥} ( t ) {τ}_{AB} )}^{2} . & ( 3.1 )\end{matrix}$$

Solving for τ_{AB} gives:

$${τ}_{AB} = \frac{τ}{\sqrt{{( 1 + {v}_{A} ( t ) / c )}^{2} + {( {v}_{A}^{⊥} ( t ) / c )}^{2}}} . \qquad ( 3.11 )$$

This proves Equation 3.6. The proof of 3.7 is the same.

In the foregoing, note that the effects of

$${v}_{A}^{⊥} ( t ) and {v}_{B}^{⊥} ( t )$$

are expected to be sufficiently small that they may be ignored. To understand this, the radicand of the denominator of Equation 3.11 may be expanded as follows:

$${( 1 + {υ}_{A} ( t ) / c )}^{2} + {( {υ}_{A} \frac{1}{A} ( t ) / c )}^{2} = 1 + 2 \frac{{υ}_{A} ( t )}{c} + {( \frac{{υ}_{A} ( t )}{c} )}^{2} + {( \frac{υ \frac{1}{A} ( t )}{c} )}^{2} . \qquad ( 3.12 )$$

Even for velocities as experienced by satellites, at most on the order of 10 km/s,

$$υ \frac{1}{A} / c \approx {10}^{- 4} , {( υ \frac{1}{A} ( t ) / c )}^{2} \approx {10}^{- 8} ,$$

and similarly for the (v_{A}(t)/c)² term. Thus in comparison to the linear 2v_{A}(t)/c term, the second order terms may be ignored. Indeed, Lemma 1 then may be simplified by noting that

$$\begin{matrix}\begin{matrix}\begin{matrix}\sqrt{{( 1 + \frac{{υ}_{A} ( t )}{c} )}^{2} + {( \frac{υ \frac{1}{B} ( t )}{c} )}^{2}} \approx \sqrt{1 + 2 {υ}_{A} ( t ) / c} & \\ \approx 1 + {υ}_{A} ( t ) / c , & ( 3.14 )\end{matrix}\end{matrix} \\ \end{matrix} \qquad ( 3.13 )$$

$$\begin{matrix}\begin{matrix}\sqrt{{( 1 + \frac{{υ}_{B} ( t )}{c} )}^{2} + {( \frac{υ \frac{1}{B} ( t )}{c} )}^{2}} \approx \sqrt{1 + 2 {υ}_{B} ( t ) / c} & \\ \approx 1 + {υ}_{B} ( t ) / c . & ( 3.16 )\end{matrix}\end{matrix} \qquad ( 3.15 )$$

As such, Lemma 1 may be simplified to the expression:

$$\begin{matrix}{τ}_{A B} ( t ) & = \frac{τ ( t )}{1 + {υ}_{A} ( t ) / c} ,\end{matrix} \qquad ( 3.17 )$$

$$\begin{matrix}{τ}_{B A} ( t ) & = \frac{τ ( t )}{1 + {υ}_{B} ( t ) / c} .\end{matrix} \qquad ( 3.18 )$$

Lemma 1 expresses the true delays, from transceiver A 110 to transceiver B 120, and from transceiver B to transceiver A, in terms of τ(t). For notational simplicity, the following expressions may be used:

$${k}_{A} ( t ) = \sqrt{{( 1 + {υ}_{A} ( t ) / c )}^{2} + {( υ \frac{1}{A} ( t ) / c )}^{2}} , \qquad ( 3.19 )$$

$${k}_{B} ( t ) = \sqrt{{( 1 + {υ}_{B} ( t ) / c )}^{2} + {( υ \frac{1}{B} ( t ) / c )}^{2}} . \qquad ( 3.2 )$$

It may be assumed that the transceiver velocities are sufficiently low that over a period of approximately one second or less, k_{A}(t) and k_{B}(t) may be treated as constants: k_{A}(t)=k_{A} and k_{B}(t)=k_{B}. With this notation, Lemma 1 may be re-expressed as:

$${τ}_{A B} ( t ) = \frac{τ ( t )}{{k}_{A}} , \qquad ( 3.21 )$$

$${τ}_{B A} ( t ) = \frac{τ ( t )}{{k}_{B}} . \qquad ( 3.22 )$$

As noted further above,
τ_{A}(t) [symbol] transceiver A 110's propagation delay estimate for the signal it receives at universal time t (of clock 111), and
τ_{B}(t) [symbol] transceiver B 120's propagation delay estimate for the signal it receives at universal time t.

From this, the following observation follows:

$${τ}_{A} ( t ) = {τ}_{B A} ( t ) + θ ( t − {τ}_{B A} ( t ) ) , \qquad ( 3.23 )$$

$${τ}_{B} ( t ) = {τ}_{A B} ( t ) − θ ( t ) .$$

Plugging in Equations 3.21 and 3.22 into Equations 3.23 provides the expressions:

$${τ}_{A} ( t ) = \frac{τ ( t )}{{k}_{B}} + θ ( t − τ ( t ) / {k}_{B} ) , \qquad ( 3.24 )$$

$${τ}_{B} ( t ) = \frac{τ ( t )}{{k}_{A}} − θ ( t ) . \qquad ( 3.25 )$$

Because the signal propagations 231 and 232 occur at the speed of light, their durations are relatively short and it may be assumed that the distance among the transceivers 110, 120 and their respective clock offsets vary as a linear function of time during the signal propagation:

$$τ ( t ) = a + bt , \qquad ( 3.26 )$$

$$θ ( t ) = α + β t , \qquad ( 3.27 )$$

for some constants a, b, α, β.

Plugging Equations 3.26 and 3.27 into Equations 3.24 and 3.25 and performing some algebra gives the expressions:

$${τ}_{A} ( t ) = [ \frac{a ( 1 − β )}{{k}_{B}} + α ] + [ \frac{b ( 1 − β )}{{k}_{B}} + β ] t , \qquad ( 3.28 )$$

$${τ}_{B} ( t ) = [ \frac{a}{{k}_{A}} − α ] + [ \frac{b}{{k}_{A}} − β ] t . \qquad ( 3.29 )$$

Equations 3.28 and 3.29 show that for both transceiver A 110 and transceiver B 120, the estimated delays over a collection of received signals is linearly related to universal time t of transceiver A's clock 110. However, transceiver B 120 operates relative to its own clock 121 with offset B(t). So it is useful to express Equation 3.29 as a function of B(t). To do so, recall that for the clock offset θ(t) (see Equation 2.1), the time shown on clock B 121 at universal time t may be expressed as:

$$B ( t ) = t - θ ( t ) . \qquad ( 3.3 )$$

Plugging Equation 3.27 into Equation 3.30 and performing some algebra gives the expression:

$$t = \frac{α + B ( t )}{1 - β} . \qquad ( 3.31 )$$

Plugging Equation 3.31 into Equation 3.29 and doing some algebra gives the expression:

$${τ}_{B} ( t ) = [ \frac{a}{{k}_{A}} − α + α \frac{\frac{b}{{k}_{A}} − β}{1 − β} ] + [ \frac{\frac{b}{{k}_{A}} − β}{1 − β} ] B ( t ) . \qquad ( 3.32 )$$

From the foregoing, the following linear relations may be obtained:

$${τ}_{A} ( t ) = [ \frac{a ( 1 − β )}{{k}_{B}} + α ] + [ \frac{b ( 1 − β )}{{k}_{B}} + β ] t , \qquad ( 3.33 )$$

$${τ}_{B} ( t ) = [ \frac{a}{{k}_{A}} + α \frac{\frac{b}{{k}_{A}} − 1}{1 − β} ] + [ \frac{\frac{b}{{k}_{A}} - β}{1 − β} ] B ( t ) . \qquad ( 3.34 )$$

Equation 3.33 describes the linear relationship between the propagation delay estimates and the signal arrival times for transceiver A 110, and Equation 3.34 describes the linear relationship between the propagation delay estimates and the signal arrival times for transceiver B 120. The respective y-intercepts y_{A}, y_{B} and slopes s_{A}, s_{B} of Equations 3.33 and 3.34 may be expressed as:

$${y}_{A} = [ \frac{a ( 1 − β )}{{k}_{B}} + α ] , \qquad ( 3.35 )$$

$${s}_{A} = [ \frac{b ( 1 − β )}{{k}_{B}} + β ] , \qquad ( 3.36 )$$

$${y}_{B} = [ \frac{a}{{k}_{A}} + α \frac{\frac{b}{{k}_{A}} - 1}{1 − β} ] , \qquad ( 3.37 )$$

$${s}_{B} = [ \frac{\frac{b}{{k}_{A}} - β}{1 − β} ] . \qquad ( 3.38 )$$

The constants k_{A} and k_{B} are assumed to be known (that is,

$${v}_{A} , v \frac{1}{A} , {v}_{B} , v \frac{1}{B}$$

are known), e.g., in a manner such as will be explained in Section 8.

Equations 3.33 and 3.34 provide two nonlinear equations in the four unknowns a, b, α, β which are linearly dependent on time. As provided herein, transceiver A 110 may be configured to estimate the time-varying range and time-varying clock offset between transceiver A 110 and transceiver B 120 using operations that include calculating the estimated delay of signals arriving at a succession of times t₁, t₂, . . . . From Equations 3.33 and 3.34, these delays may be expected to lie approximately on a line with slope s_{A} and y-intercept y_{A}. Similarly, as provided herein, transceiver B 120 may be configured to estimate the time-varying range and time-varying clock offset between transceiver A 110 and transceiver B 120 using operations that include calculating the estimated delay of signals arriving at a succession of times B(t₁), B(t₂), . . . . From Equations 3.33 and 3.34, these delays may be expected to lie approximately on a line with slope s_{B} and y-intercept y_{B}. Accordingly, in some examples, transceiver A 110 further is configured to estimate the arrival times and delays of the received signals, to find the best fit straight line through the estimated delays, and then to determine the y-intercept and slope, y_{A} and s_{A}, of that best fit straight line. Similarly, in some examples, transceiver B 120 further is configured to estimate the arrival times and delays of the received signals, to find the best fit straight line through the estimated delays, and then to determine the y-intercept and slope, y_{B} and s_{B}, of that best fit straight line. The values y_{A}, s_{A}, y_{B}, and s_{B} correspond to the four equations in the four unknowns a, b, α, β given in Equations 3.35-3.38.

Note that solving for y_{A} and s_{A} in Equation 3.33 (and similarly solving for y_{B} and s_{B} in Equation 3.34) via a best fit straight line fit to the data (tᵢ, τ_{A}(tᵢ)) and (tᵢ, τ_{B}(tᵢ)) may use a nonlinear operation, e.g., using Equations 4.1 and 4.2. However, Equations 3.33 (and 3.34) instead may be used as a linear system of equations, saving computation. This approach also allows efficient computation of cov(y_{A}, s_{A}) and cov(y_{B}, s_{B}) in a manner such as described in Section 5.

In some examples, transceiver A 110 and/or transceiver B 120 are configured to solve Equations 3.35-3.38 for a, b, α, β. Some algebra provides the following solution for a, b, α, and β in terms of v_{A}, s_{A}, y_{B}, and s_{B}:

$$β = \frac{- y - \sqrt{{y}^{2} - 4 xz}}{2 x} , \qquad ( 3.39 )$$

$$b = \frac{( {s}_{A} - β ) {k}_{B}}{1 - β} , \qquad ( 3.4 )$$

$$a = \frac{{y}_{B} - {y}_{A} \frac{( b / {k}_{A} ) - 1}{1 - β}}{\frac{1}{{k}_{A}} - \frac{( b / {k}_{A} ) - 1}{{k}_{B}}} , \qquad ( 3.41 )$$

$$α = {y}_{A} = \frac{a ( 1 - β )}{{k}_{B}} , \qquad ( 3.42 )$$

$$where$$

$$x {=}^{def} 1 - {s}_{B} , \qquad ( 3.43 )$$

$$y {=}^{def} {k}_{A} {s}_{B} - {k}_{B} - ( 1 - {s}_{B} ) / {k}_{A} , \qquad ( 3.44 )$$

$$z {=}^{def} {s}_{A} {k}_{B} - {k}_{A} {s}_{B} . \qquad ( 3.45 )$$

In a manner such as described in Section 4, these relationships may be used for a two-way time transfer and ranging protocol for a constrained communication link. In Section 6, optional performance improvements using Kalman filtering are described. In Section 7, the optional use of transceiver frequency offset estimates in the Kalman Filter architecture is described.

### 4. Communication-Link Based Two-Way Time Transfer and Ranging

As described in Section 2, to implement two-way time transfer, it is useful for a transceiver to determine a signal's arrival time and to know the signal's transmit time. In previously known schemes, ranging signals are used that include an acquisition sequence which may be used by the transceiver to determine signal arrival time, and a transmit time-stamp. However, processing these ranging signals may use an undesirable amount of the transceiver's bandwidth and processor time, at the cost of reduced bandwidth and processor time for processing communication signals. As recognized by the present inventors, transceivers may be modified to determine signal arrival time and transmit time from communication signals, without the need for a separate ranging signal. Accordingly, the present transceivers are expected to have significantly better bandwidth and utilization efficiency.

More specifically, in a communication link, symbol timing synchronization provides the arrival time of each symbol. In some examples, for a first transceiver to know each symbol's transmit time from a second transceiver, the first and second transceivers may be configured to use a communication protocol in which symbols are transmitted at predetermined times. For example, the transceivers may be configured to initiate transmission of a string of symbols of a communication signal at any suitable time, to include the transmit the time of the first symbol within the transmission, and to transmit the symbols at an a priori known symbol rate. When the other transceiver then receives the communication signal, that transceiver then may use the included transmission time of the first symbol and the known symbol rate to determine the transmit time of each symbol in the signal. As such, and as recognized by the present inventors, each symbol in the received communication signal constitutes a signal for which both an arrival time estimate and a transmit time are determined by the receiving transceiver.

Recall that Section 3 considered two-way time transfer for linearly time varying range and clock offset. In reality, the range and clock offset for an actual system may vary nonlinearly with time. An example feature of the communication-link-based time transfer protocol provided herein is that many symbols may be transmitted over short windows of time, during which windows the system dynamics may be assumed to be approximately linearly varying as a function of time. In such a situation, all the equations given in Section 3 may provide accurate approximations for each time-transfer window.

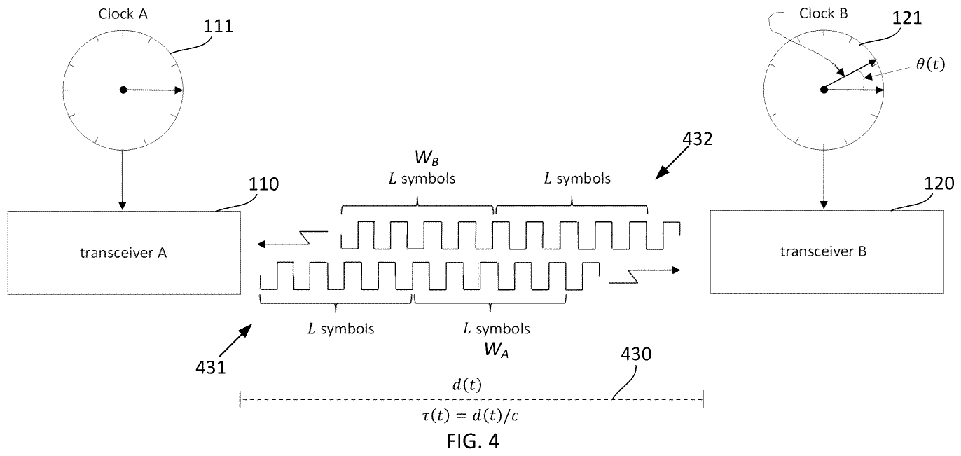

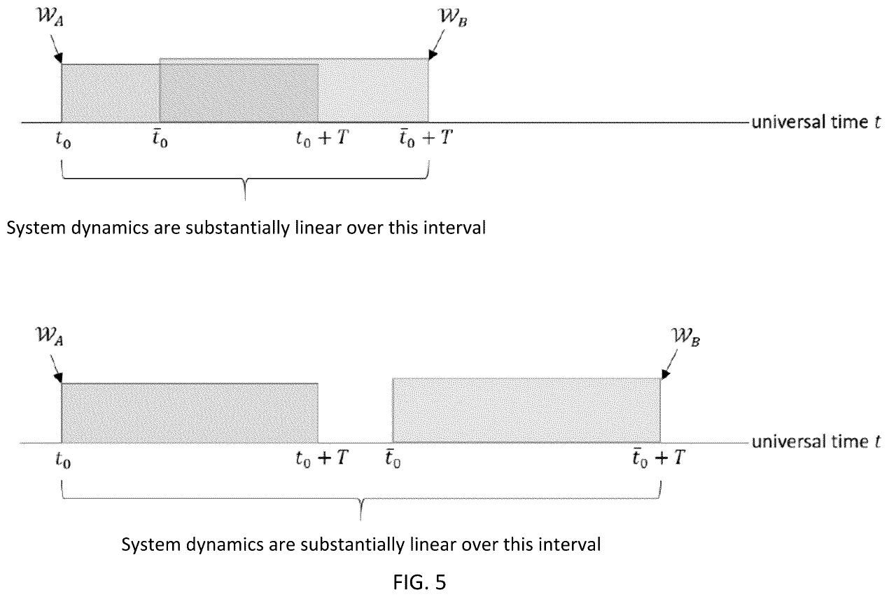

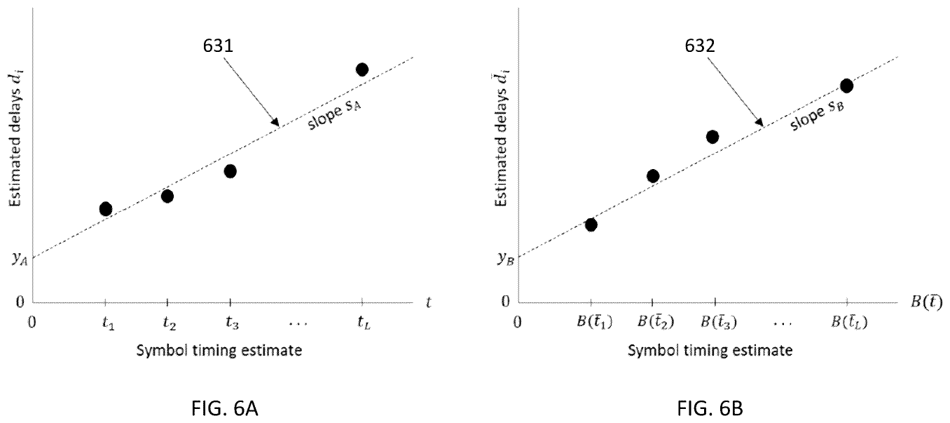

FIG. 4 illustrates an example two-way time transfer and ranging architecture in which transceiver A 110 is separated from transceiver B 120 by a time-varying range d(t) 430, and in which clock A 111 of transceiver 110 is offset from clock B 121 of transceiver 120 by time-varying clock offset θ(t). In the illustrated example, transceiver A 110 is configured to determine a delay estimate for each symbol in a sequence of L received symbols transmitted by transceiver B 120 in communication signal 432, and transceiver B 120 is configured to determine a delay estimate for each symbol in a sequence of L received symbols transmitted by transceiver B 120 in communication signal 431. Each L-symbol sequence may be referred to as twtt window which may be represented with the symbol W, and the window's duration in seconds may be represented with the symbol T. Recall that t is referred to as universal time which may be expressed as the time shown on clock A 111 of transceiver 110. With respect to universal time, transceiver A 110 may be configured to process the received symbols within a T-duration, L-symbol-length twtt window WA which spans the universal time interval [t₀, t₀+7] of communication signal 432. Similarly, transceiver B 120 may be configured to process the received symbols within a T-duration, L-symbol-length twtt window W_{B} which spans the universal time interval [t̅₀, t̅₀+7] of communication signal 431. The two intervals [t₀, t₀+7] and [t̅₀, t̅₀+7] need not be the same interval, and in fact need not even overlap, but preferably occupy an overall time interval over which the system dynamics (e.g., distance, clock offset and their rates) are stable, e.g., substantially linear. This is depicted in FIG. 5, which illustrates example positioning of transceivers' two-way time transfer windows, e.g., allowable positioning of twtt window WA of transceiver A 110 and twtt window W_{B} of transceiver B 120. FIGS. 6A-6B illustrate example transceiver processing of symbols arriving during two-way time transfer windows, e.g., such as illustrated in FIG. 5.

The data in window WA illustrated in FIG. 5 may be expressed as

$${\{ ( {t}_{i} , {d}_{i} ) \}}_{i = 1}^{L}$$

for the L data points in the window, in which the tᵢ are the symbol arrival time estimates, and the dᵢ are the associated delay estimates. These points may be thought of as lying on a grid in a manner such as illustrated in FIG. 6A, although they need not actually be plotted on a grid. In some examples, transceiver A 110 may be configured to determine the best fit straight line 631 through the data points and to determine the y-intercept and slope, y_{A} and s_{A}, of that line in a manner such as illustrated in FIG. 6A. Transceiver B 120 may be configured to perform similar operations on data {(B(t̅ᵢ),d̅ᵢ)} in window W_{B}, the points of which similarly may be thought of as lying on a grid in a manner such as illustrated in FIG. 6B. Transceiver B 120 similarly may be configured to determine the best fit straight line 632 through the data points and to determine the y-intercept and slope, y_{B} and s_{B}, of that line in a manner such as illustrated in FIG. 6B. In this regard, note that transceiver B 120 operates with respect to its own clock 121 using B(t) which is offset from universal time t.

By transceiver A 110, the equations for determining the y-intercept and slope, y_{A} and s_{A}, may be calculated as:

$${s}_{A} = 1 - \frac{( \sum {t}_{i} ) ( \sum {b}_{i} ) - L \sum {b}_{i} {t}_{i}}{{( \sum {t}_{i} )}^{2} - L \sum {t}_{i}^{2}} \qquad ( 4.1 )$$

$${y}_{A} = \frac{( 1 - {s}_{A} ) \sum {t}_{i}^{2} - \sum {b}_{i} {t}_{i}}{\sum {t}_{i}} , \qquad ( 4.2 )$$

where bᵢ [symbol] tᵢ−dᵢ. Notice that the bᵢ are the symbol scheduled transmit times, according to transceiver B 120's clock 121. The equations for y_{B} and s_{B} are similar to Equations 4.1 and 4.2, with the substitutions:

$$\begin{matrix}{t}_{i} B ( {\overline{t}}_{i} ) \\ {b}_{i} {\overline{b}}_{i} = B ( {\overline{t}}_{i} ) - {\overline{d}}_{i} .\end{matrix}$$

Considering one transceiver, say transceiver A 110, the transformation from

$$\{ ( {t}_{i} , {d}_{i} ) \} \{ {A}_{} , {s}_{A} \}$$

may be thought of as a transformation of random variables, where the statistics of {(tᵢ, dᵢ)} are driven by the variance of the symbol timing errors σ² and it is desired to determine the covariance cov(y_{A}, s_{A}) of y_{A} and s_{A}. In some examples, this covariance may be obtained using the optional Kalman filter implementation in subsequent sections, so an example manner of computing it is provided here.

Equations 4.1 and 4.2 describe s_{A} and y_{A} in terms of the tᵢ and bᵢ. The statistics of the tᵢ are known, since the receiver symbol timing loop is designed to achieve a given performance. Accordingly, the statistics (e.g., covariance) of s_{A} and y_{A} may be determined through the local linear relationships between y_{A} and s_{A} and the tᵢ. Note that the delay estimate dᵢ is the difference between the estimated symbol arrival time tᵢ and the predetermined symbol transmit time. As such, if λᵢ is used to represent the predetermined transmit time for symbol i, then bᵢ=tᵢ−dᵢ=tᵢ−(tᵢ−λᵢ)=λᵢ. That is, bᵢ is the predetermined transmit time, which does not depend on tᵢ. Determining the local linear relationship between y_{A}, s_{A} and the tᵢ is a matter of differentiating Equations 4.1 and 4.2 with respect to the tᵢ. This may be done either symbolically or numerically.

For example, writing P for the 2×L partial derivative matrix

$$P = [ \begin{matrix}\frac{\partial {y}_{A}}{\partial {t}_{1}} & \frac{\partial {y}_{A}}{\partial {t}_{2}} & ⋯ & \frac{\partial {y}_{A}}{\partial {t}_{L}} \\ \frac{\partial {s}_{A}}{\partial {t}_{1}} & \frac{\partial {s}_{A}}{\partial {t}_{2}} & ⋯ & \frac{\partial {s}_{A}}{\partial {t}_{L}}\end{matrix} ] \qquad ( 4.3 )$$

and noting that the covariance matrix of the tᵢ is:

$$cov ( {t}_{i} , {t}_{j} ) = [ \begin{matrix}{σ}^{2} & & \\ & ⋱ & \\ & & {σ}^{2}\end{matrix} ] \qquad ( 4.4 )$$

this provides, from the usual covariance transformation under linear transformations,

$$cov ( {y}_{A} , {s}_{A} ) = P cov ( {t}_{i} , {t}_{j} ) {P}^{T} . \qquad ( 4.5 )$$

In some examples, transceiver A 110 computes equations 4.3, 4.4, and 4.5. In similar fashion, transceiver 120 may compute cov(y_{B}, s_{B}). Illustratively, the covariance computation may be used as part of the Kalman filter implementation described elsewhere herein.

In some examples, after determining the y-intercepts and slopes y_{A}, s_{A} for the data it receives, transceiver A 110 shares these values with transceiver B 120 over the communication link. Similarly, after determining the y-intercepts and slopes y_{B}, s_{B} for the data it receives, transceiver B 120 shares these values with transceiver A 110 over the communication link. Note, however that while a given one of the transceivers A 110, B 120 may use all four values y_{A}, s_{A}, y_{B}, s_{B} in order to generate its own estimate of the time-varying range and time-varying clock offset between transceivers A and B, that transceiver need not necessarily transmit its y-intercepts and slopes to the other transceiver. Illustratively, transceiver A 110 may calculate y_{A}, s_{A}, and transceiver B 120 may calculate y_{B}, s_{B} and transmit those values to transceiver A for transceiver A's use in estimating the time-varying range and time-varying clock offset between transceivers A and B; however, transceiver A need not necessarily transmit y_{A}, s_{A} to transceiver B, and as such, transceiver B may not necessarily also estimate the time-varying range and time-varying clock offset between transceivers A and B. Similarly, transceiver B 120 may calculate y_{B}, s_{B} and transceiver A 110 may calculate y_{A}, s_{A} and transmit those values to transceiver B for transceiver B's use in estimating the time-varying range and time-varying clock offset between transceivers A and B; however, transceiver B need not necessarily transmit y_{B}, s_{B} to transceiver A, and as such, transceiver A may not necessarily also estimate the time-varying range and time-varying clock offset between transceivers A and B. In other examples, the transceivers exchange their respective y-intercepts and slopes, and as such both transceivers may estimate the time-varying range and time-varying clock offset between transceivers A and B.

In some examples, transceiver A 110 and/or transceiver B 120 may be configured to use Equations 3.39-3.41 to generate an estimate of the system state a₀, b₀, α₀, and β₀ (the distance, velocity, clock offset, and offset rate, respectively) at time t=0. In some examples, transceiver A 110 and/or transceiver B 120 may be configured to propagate this system state forward to time t₁ to obtain the state estimate [aₜ_{₁},bₜ_{₁},αₜ_{₁},βₜ_{₁}]^{T} at the beginning of window W_{A}. This state estimate may be denoted zₜ_{₁}; that is,

$$z {=}^{def} {[ {a}_{{t}_{1}} , {b}_{{t}_{1}} , {α}_{{t}_{1}} , {β}_{{t}_{1}} ]}^{T} . \qquad ( 4.6 )$$

Note that for c the speed of light, caₜ_{₁} is the estimated distance between transceiver A 110 and transceiver B 120 at time t₁, and cbₜ_{₁} is the estimated velocity between transceiver A 110 and transceiver B 120 at time t₁.

In a manner such as described in Section 6, transceiver A 110 and/or transceiver B 120 optionally may use a Kalman filter to smooth out these local state estimates to provide better, and smoother, performance.

A transceiver receiving a signal via a communication link also may be configured to estimate the frequency offset between the carrier frequency of the arriving signal and its own local oscillator frequency. As recognized by the present inventors, this information may be used to further improve state estimation. For example, the computed carrier offset is a function of Doppler shift and carrier clock offset rate. In such, the carrier offset provides information about the propagation delay rate (the relative velocity). It further may be assumed that the carrier clocks and symbol clocks on the transceivers are locked to one another (are driven by a common clock), so the carrier offset also provides a symbol clock offset rate estimate. This information may be leveraged to improve two-way time transfer clock synchronization and transceiver range estimation. An example structure to incorporate carrier offset information a Kalman filter, e.g., in a manner such as described in Section 7.

### 5. Efficient Fit

In a manner such as described in Section 3, transceiver A 110 may be configured to determine the linear coefficients y_{A} and s_{A} by fitting a line to the data (tᵢ, τ_{A}(tᵢ)) governed by Equation 3.33. Equations 4.1 and 4.2 express an example set of equations that are solved (for example, by transceiver A 110) to determine y_{A}, s_{A}, where the dᵢ=τ_{A}(tᵢ). Notice that the bᵢ [symbol] tᵢ−dᵢ are the scheduled symbol transmit times. Transceiver B 120 may be configured to determine the linear coefficients y_{B} and s by fitting a line to the data (tᵢ, τB(tᵢ)) governed by Equation 3.34, and using equations similar to Equations 4.1 and 4.2.

There are two inefficiencies in Equations 4.1 and 4.2. First, each symbol arrival time estimate tᵢ may be squared, which is computationally intensive. Second, if using 4.1 and 4.2, determining cov(y_{A}, s_{A}) from the statistics of the tᵢ is not straightforward. However, Equations 4.1 and 4.2 may be expressed in a manner that both provides a substantially linear solution for y_{A} and s_{A} and offers a more efficient way to compute cov(y_{A}, s_{A}), and similar expressions may be provided for a substantially linear solution for y_{B} and s_{B} and a more efficient way to compute COV (y_{B}, s_{B}).

More specifically, the following relationships may be expressed:

$${\{ {\overline{t}}_{k} \}}_{k = 1}^{L} {=}^{def}$$

transceiver A 110's L symbol-spaced transmit times in a twtt window, according to transceiver A's clock 111.

$${\{ {\overline{b}}_{k} \}}_{k = 1}^{L} {=}^{def}$$

transceiver B 120's L symbol-spaced transmit times in a twtt window, according to B's clock 121.

$${\{ {t}_{k} \}}_{k = 1}^{L} {=}^{def}$$

transceiver A 110's L symbol arrival times, according to transceiver A's clock 111.

$${\{ {b}_{k} \}}_{k = 1}^{L} {=}^{def}$$

transceiver B 120's L symbol arrival times, according to transceiver B's clock 121.

In this, note that the arrival times tₖ are the arrival times of the symbols that transceiver B 120 sent at times b̅ₖ. Similarly, the arrival times bₖ are the arrival times of the symbols that transceiver A 110 sent at times t̅ₖ.

Recall that for every received symbol, the transceivers form the delay estimates

$${τ}_{A} ( k ) {=}^{def} {t}_{k} - {\overline{b}}_{k} , \qquad ( 5.1 )$$

$${τ}_{B} ( k ) {=}^{def} {b}_{k} - {\overline{t}}_{k} , \qquad ( 5.2 )$$

and equations 3.33 and 3.34 describe that these delay estimates are linearly related to the symbol arrival times

$${T}_{A} ( k ) {=}^{def} {t}_{k} − {\overline{b}}_{k} = {y}_{A} + {s}_{A} {t}_{k} , \qquad ( 5.3 )$$

$${T}_{B} ( k ) {=}^{def} {b}_{k} − {\overline{t}}_{k} = {y}_{B} + {s}_{B} {b}_{k} . \qquad ( 5.4 )$$

Rearranging using algebra gives

$${t}_{k} = ( \frac{{y}_{A}}{1 − {s}_{A}} ) + ( \frac{1}{1 − {s}_{A}} ) {\overline{b}}_{k} , \qquad ( 5.5 )$$

$${b}_{k} = ( \frac{{y}_{B}}{1 − {s}_{B}} ) + ( \frac{1}{1 − {s}_{B}} ) {\overline{t}}_{k} . \qquad ( 5.6 )$$

Equations 5.5 and 5.6 may be expressed in matrix form by aggregating all estimates within a processing block. In particular, the following expressions may be used:

$$\begin{matrix}\overline{t} {=}^{def} [ \begin{matrix}{\overline{t}}_{1} \\ ⋮ \\ {\overline{t}}_{L}\end{matrix} ] & \underline{\overline{b}} {=}^{def} [ \begin{matrix}{\overline{b}}_{1} \\ ⋮ \\ {\overline{b}}_{L}\end{matrix} ] \\ t {=}^{def} [ \begin{matrix}{t}_{1} \\ ⋮ \\ {t}_{L}\end{matrix} ] & b {=}^{def} [ \begin{matrix}{b}_{1} \\ ⋮ \\ {b}_{L}\end{matrix} ]\end{matrix}$$

Then Equations 5.5 and 5.6 may be expressed as:

$$t = [ \begin{matrix}1 & \overline{b}\end{matrix} ] [ \begin{matrix}\frac{{y}_{A}}{1 − {s}_{A}} \\ \frac{1}{1 − {s}_{A}}\end{matrix} ] , \qquad ( 5.7 )$$

$$b = [ \begin{matrix}1 & \overline{t}\end{matrix} ] [ \begin{matrix}\frac{{y}_{B}}{1 − {s}_{B}} \\ \frac{1}{1 − {s}_{B}}\end{matrix} ] . \qquad ( 5.8 )$$

Equations 5.7 and 5.8 may be solved using the normal equations:

$$[ \begin{matrix}\frac{{y}_{A}}{1 − {s}_{A}} \\ \frac{1}{1 − {s}_{A}}\end{matrix} ] = [ {( {M}_{\overline{b}}^{T} {M}_{\overline{b}} )}^{− 1} {M}_{\overline{b}}^{T} ] t , \qquad ( 5.9 )$$

$$[ \begin{matrix}\frac{{y}_{B}}{1 − {s}_{B}} \\ \frac{1}{1 − {s}_{B}}\end{matrix} ] = [ {( {M}_{\overline{t}}^{T} {M}_{\overline{t}} )}^{− 1} {M}_{\overline{t}}^{T} ] b , \qquad ( 5.1 )$$

$$where$$

$${Mb}_{\overline{b}} {=}^{def} [ \begin{matrix}1 & \overline{b}\end{matrix} ]$$

$$and$$

$${M}_{\overline{t}} {=}^{def} [ \begin{matrix}1 & \overline{t}\end{matrix} ] .$$

Having solved for y_{A}/(1−s_{A}), 1/(1−s_{A}), y_{B}/(1−s_{B}) and 1/(1−s_{B}), solving for y_{A}, s_{A}, y_{B}, and s_{B} is straight forward. For example, the following relationships may be used:

$${λ}_{A} {=}^{def} \frac{{y}_{A}}{1 − {s}_{A}} , \qquad ( 5.11 )$$

$${μ}_{A} {=}^{def} \frac{1}{1 − {s}_{A}} , \qquad ( 5.12 )$$

$${λ}_{B} {=}^{def} \frac{{y}_{B}}{1 − {s}_{B}} , \qquad ( 5.13 )$$

$$\begin{matrix} & {μ}_{B} {=}^{def} \frac{1}{1 − {s}_{B}} .\end{matrix} \qquad ( 5.14 )$$

Then,

$${y}_{A} = \frac{{λ}_{A}}{{μ}_{A}} , \qquad ( 5.15 )$$

$${y}_{A} = \frac{{μ}_{A} − 1}{{μ}_{A}} , \qquad ( 5.16 )$$

$${y}_{B} = \frac{{λ}_{B}}{{μ}_{B}} , \qquad ( 5.17 )$$

$${s}_{B} = \frac{{μ}_{B} − 1}{{μ}_{B}} . \qquad ( 5.18 )$$

Notice that Equations 5.7 and 5.8 may be rewritten as:

$$t = [ \begin{matrix}1 & \overline{b}\end{matrix} ] [ \begin{matrix}{λ}_{A} \\ {μ}_{A}\end{matrix} ] = [ \begin{matrix}1 & {b}^{=} + \overline{b} ( 1 )\end{matrix} ] [ \begin{matrix}{λ}_{A} \\ {μ}_{A}\end{matrix} ] , \qquad ( 5.19 )$$

$$b = [ \begin{matrix}1 & \overline{t}\end{matrix} ] [ \begin{matrix}{λ}_{B} \\ {μ}_{B}\end{matrix} ] = [ \begin{matrix}1 & {t}^{=} + \overline{t} ( 1 )\end{matrix} ] [ \begin{matrix}{λ}_{B} \\ {μ}_{A}\end{matrix} ] , \qquad ( 5.2 )$$

$$where$$

$${b}^{=} = {t}^{=} = [ \begin{matrix}0 \\ {T}_{s} \\ 2 {T}_{s} \\ ⋮ \\ ( L − 1 ) {T}_{s}\end{matrix} ] \text{?} \qquad ( 5.21 )$$

$$\text{?} \text{indicates text missing or illegible when filed}$$

and Tₛ is the symbol period. The expressions and may be used as the solutions to:

$$\begin{matrix} & t = [ \begin{matrix}1 & {b}^{=}\end{matrix} ] [ \begin{matrix}{λ}_{A}^{⋆} \\ {μ}_{A}^{⋆}\end{matrix} ]\end{matrix} \qquad ( 5.22 )$$

$$b = [ \begin{matrix}1 & {t}^{=}\end{matrix} ] [ \begin{matrix}{λ}_{B}^{⋆} \\ {μ}_{B}^{⋆}\end{matrix} ] . \qquad ( 5.23 )$$

It will be shown below that Equations 5.22 and 5.23 may be solved efficiently in closed form. Assuming this, some algebra shows that

$$[ \begin{matrix}{λ}_{A} \\ {μ}_{A}\end{matrix} ] = [ \begin{matrix}{λ}_{A}^{⋆} − \vert \overline{b} ( 1 ) {μ}_{A}^{⋆} \\ {μ}_{A}^{⋆}\end{matrix} ] , \qquad ( 5.24 )$$

$$[ \begin{matrix}{λ}_{B} \\ {μ}_{B}\end{matrix} ] = [ \begin{matrix}{λ}_{B}^{⋆} − \overline{t} ( 1 ) {μ}_{B}^{⋆} \\ {μ}_{B}^{⋆}\end{matrix} ] , \qquad ( 5.25 )$$

The closed form solutions to Equations 5.22 and 5.23 now will be derived. Notice that

$$M {=}^{def} {M}_{{b}^{=}} = {M}_{{t}^{=}} . \qquad ( 5.26 )$$

The solutions to Equations 5.22 and 5.23 then may be expressed as:

$$[ \begin{matrix}{λ}_{A}^{⋆} \\ {μ}_{A}^{⋆}\end{matrix} ] = t , \qquad ( 5.27 )$$

$$[ \begin{matrix}{λ}_{B}^{⋆} \\ {μ}_{B}^{⋆}\end{matrix} ] = b , \qquad ( 5.28 )$$

$$where$$

$${=}^{def} {( {M}^{T} M )}^{− 1} {M}^{T} . \qquad ( 5.29 )$$

Because the vectors b̅ and t̅ are relatively simple, [symbol] may be computed in closed form. In particular, a straight forward computation gives the expressions:

$${M}^{T} M = [ \begin{matrix}L & {T}_{s} ( L − 1 ) L / 2 \\ {T}_{s} ( L − 1 ) L / 2 & {T}_{s}^{2} ( L − 1 ) L ( 2 L − 1 ) / 6\end{matrix} ] , \qquad ( 5.3 )$$

$${( {M}^{T} M )}^{− 1} = D [ \begin{matrix}{T}_{s}^{2} ( L − 1 ) ( 2 L − 1 ) / 6 & − {T}_{s} ( L − 1 ) / 2 \\ − {T}_{s} ( L − 1 ) / 2 & 1\end{matrix} ] , \qquad ( 5.31 )$$

$$and$$

$$= D [ \begin{matrix}x & x − 1 z & x − 2 z & ⋯ & x − ( L − 1 ) z \\ y & y + {T}_{s} & y + 2 {T}_{s} & ⋯ & y + ( L − 1 ) {T}_{s}\end{matrix} ] \qquad ( 5.32 )$$

$$where ,$$

$$D = \frac{12}{{T}_{z}^{2} ( L − 1 ) L ( L + 1 )} . \qquad ( 5.33 )$$

$$x = \frac{{T}_{s}^{2} ( L − 1 ) ( 2 L − 1 )}{6} . \qquad ( 5.34 )$$

$$y = − \frac{{T}_{s} ( L − 1 )}{2} . \qquad ( 5.35 )$$

$$z = \frac{{T}_{s}^{2} ( L − 1 )}{2} . \qquad ( 5.36 )$$

As noted further above, transceiver A 110 also may be configured to determine cov(y_{A}, s_{A}), and/or transceiver B 120 also may be configured to determine cov(y_{B}, s_{B}). Determining cov(y_{*}, S_{*}) from cov (λ_{*}, μ_{*})—where (y_{*}, s_{*}) stands for either (y_{A}, s_{A}) or (y_{B}, s_{B}) and similarly (λ_{*}, μ_{*}) stands for either (λ_{A}, μ_{A}) or (λ_{B}, μ_{B})—involves locally linearizing Equations 5.15-5.18 and using the well-known covariance formula for the linear transformation of random variables (that is, If u=Mv, then cov(u)=Mcov(v)M^{T}. Linearizing relations 5.15-5.18 gives the expression:

$$( {{y}_{⋆} \atop {s}_{⋆}} ) = [ \begin{matrix}\frac{1}{{μ}_{⋆}} & \frac{− λ \text{?}}{{μ}_{⋆}^{2}} \\ 0 & \frac{1}{{μ}_{⋆}^{2}}\end{matrix} ] ( {{λ}_{⋆} \atop {μ}_{⋆}} ) , \qquad ( 5.37 )$$

$$\text{?} \text{indicates text missing or illegible when filed}$$

which gives

$$cov ( {y}_{⋆} , {s}_{⋆} ) = [ \begin{matrix}\frac{1}{μ \text{?}} & \frac{− {λ}_{⋆}}{{μ}_{⋆}^{2}} \\ 0 & \frac{i}{{μ}_{⋆}^{2}}\end{matrix} ] cov ( {λ}_{⋆} , {μ}_{⋆} ) [ \begin{matrix}\frac{i}{{μ}_{⋆}} & 0 \\ \frac{− {λ}_{⋆}}{{μ}_{⋆}^{2}} & \frac{1}{{μ}_{⋆}^{2}}\end{matrix} ] . \qquad ( 5.38 )$$

$$\text{?} \text{indicates text missing or illegible when filed}$$

Computing cov (λ*, μ*) is straightforward from 5.27 (or 5.28) and noting that

$$cov ( t ) = cov ( b ) = [ \begin{matrix}{σ}^{2} & & \\ & ⋱ & \\ & & {σ}^{2}\end{matrix} ] , \qquad ( 5.39 )$$

where σ² is the standard deviation of the symbol timing error. This provides the expressions:

$$\begin{matrix}cov ( {λ}_{*} , {μ}_{*} ) = {σ}^{2} {ℳℳ}^{T} & ( 5.4 ) \\ = {{σ}^{2} ( {M}^{T} M )}^{- 1} {M}^{T} {M ( {M}^{T} M )}^{- T} & ( 5.41 ) \\ = {{σ}^{2} ( {M}^{T} M )}^{- 1} , & ( 5.42 )\end{matrix}$$

wherein Equation 5.42 uses the fact that (M^{T}M)⁻¹ is symmetric.

Plugging Equation 5.42 into Equation 5.38 gives the expression:

$$cov ( {y}_{*} , {s}_{*} ) = {σ}^{2} [ \begin{matrix}\frac{1}{{μ}_{*}} & \frac{- {λ}_{*}}{{μ}_{*}^{2}} \\ 0 & \frac{1}{{μ}_{*}^{2}}\end{matrix} ] {( {M}^{T} M )}^{- 1} [ \begin{matrix}\frac{1}{{μ}_{*}} & 0 \\ \frac{- {λ}_{*}}{{μ}_{*}^{2}} & \frac{1}{{μ}_{*}^{2}}\end{matrix} ] , \qquad ( 5.43 )$$

Where (M^{T}M)⁻¹ is given by Equation 5.31.

### 5.1 Iterative Fit

Equations 5.27 and 5.28 provide the solution for λ_{*} and μ_{*} as a function of all symbol receive times in a twtt window, where [symbol] is expressed by Equation 5.29. As given, this provides a block solution. That is, it is computed once, after all symbols in a twtt window have been received. For an example twtt window of length 1 second and a symbol rate of 1 GHZ, matrix M would be a 2×10⁹ matrix, the block multiplication of which would be relatively large and may use a relatively large amount of memory to hold all the symbol arrival times. As recognized by the present inventors, it may be preferable for transceivers 110 and 120 to solve Equations 5.27 and 5.28 iteratively, with a small computational update for every arriving symbol. This may reduce memory requirements and may resolve the difficulty of making one relatively large computation at the end of each twtt window. Computing 5.27 and 5.28 iteratively will be described.

While the following addresses Equation 5.27, it will be appreciated that Equation 5.28 may be treated analogously. The vector t=(t₁, . . . , t_{L})^{T} is the vector of all L symbol arrival times at transceiver A 110. The vector t(i) may be expressed as the vector of the first i symbol arrival times:

$$t ( i ) {=}^{def} {( {t}_{1} , … , {t}_{i} )}^{T} . \qquad ( 5.44 )$$

[symbol] (i) may be expressed as the first i columns of the matrix [symbol] without the integral multiple D:

$$ℳ ( i ) {=}^{def} [ \begin{matrix}x & x - z & x - 2 z & ⋯ & x - ( i - 1 ) z \\ y & y + {T}_{s} & y + 2 {T}_{s} & ⋯ & y + ( i - 1 ) {T}_{s}\end{matrix} ] . \qquad ( 5.45 )$$

Notice that D [symbol] (L)t(L)= [symbol] t, from which the inventors recognized that [symbol] (i)t(i) may be computed iteratively. In particular,

$$ℳ ( i ) t ( i ) = ℳ ( i - 1 ) t ( i - 1 ) + [ \begin{matrix}( x - ( i - 1 ) z ) {t}_{i} \\ ( y + ( i - 1 ) {T}_{s} ) {t}_{i}\end{matrix} ] , \qquad ( 5.46 )$$

where x, y, z may be expressed by Equations 5.34-5.36. After the iteration is complete, providing λ_{A} and μ_{A}, applying Equations 5.15 and 5.16 solves for y_{A} and s_{A}. Transceiver A 110 may be configured to calculate the covariance cov(y_{A}, s_{A}) once at the end of the twtt window via the closed form equation 5.43. Transceiver A 110 may be configured to calculate the covariance COV (y_{A}, s_{A}) once at the end of the twtt window via the closed form equation 5.43. In some examples, transceiver A 110 transmits the values y_{A}, s_{A}, cov(y_{A}, s_{A}) to transceiver A 110, e.g., once per twtt window. Additionally, or alternatively, in some examples, transceiver B 120 transmits the values y_{B}, s_{B}, cov(y_{B}, s_{B}) to transceiver A 110, e.g., once per twtt window. In such fashion each transceiver may be configured to iteratively update its own estimates with each arriving symbol, and optionally may communicate such estimates to the other transceiver.

### 6. Kalman Filtering and Communication-Link Based Two-Way Time Transfer and Ranging

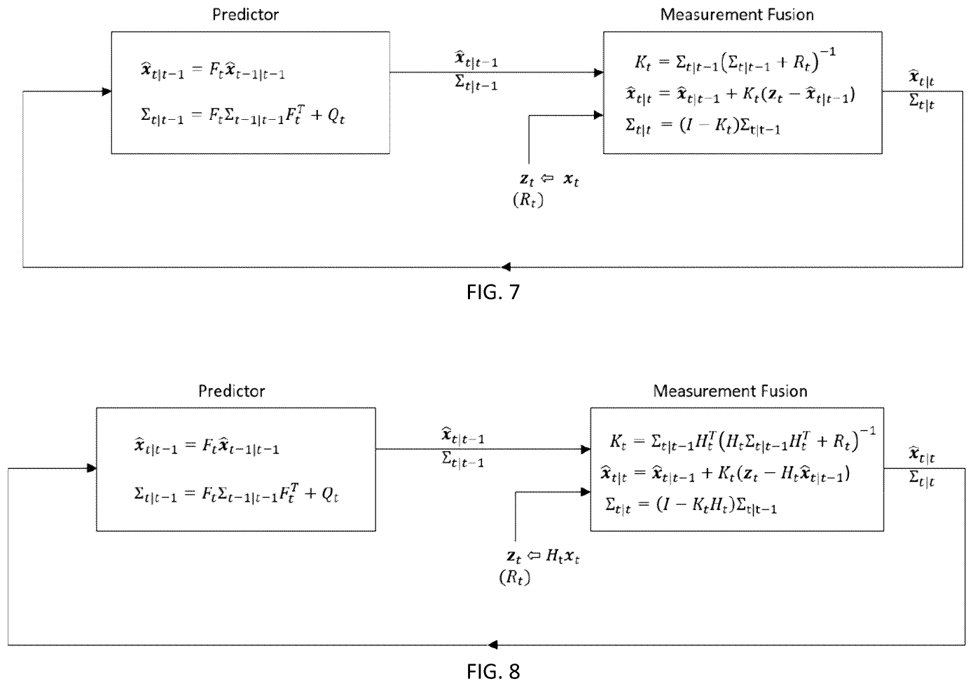

As recognized by the present inventors, state estimation may be implemented using Kalman filtering for the two cases of full state and partial observability. FIG. 7 illustrates example Kalman filtering state estimation, full state observability. FIG. 8 illustrates example Kalman filtering state estimation, partial state observability. The transceiver may be configured to implement a predictor step, in which the transceiver maps the previous state estimate \hat{x}_{t-1|t-1} and its covariance Σ_{t-1|t-1} to the current time via the state propagation operation Fₜ, which models the dynamical behavior of the system. However, this model introduces error. As such, the transceiver also may be configured to use process noise matrix Qₜ to represent model-error-induced uncertainty in the propagated state. The output of the predictor is the predicted state and covariance at time t, and may be based only on past information that arrived before time t (and thus may not include information that arrives at time t). Separately, current information (at time t) is observed, from which the transceiver generates a current observation vector zₜ (covariance Rₜ). The transceiver is configured to implement a measurement fusion step which combines the predicted state \hat{x}_{t|t-1} and the current observations zₜ, giving greater weight to the contributor with lesser uncertainty (smaller covariance). This weighting factor is the Kalman gain Kₜ, which is a function of the propagated covariance and current covariance. In the case of partial observability, FIG. 8, the same process occurs, only this time the observed data may contain indirect observations of the state elements—in particular, a linear combination of the actual state elements, as represented by the observability matrix Ht.

As recognized by the present inventors, the previous state provides some information as to the current state. So by averaging the current observation with the propagation of the previous state to the current time, the transceiver may use all available information, providing a better overall state estimate. The Kalman filtering loop (FIGS. 7 and 8) formalizes this intuition into mathematical operations.

To help explain how the Kalman filter may be implemented for the communication link-based two-way time transfer, example Kalman filter variables are listed here, and described in greater detail below.
1. The overall past state \hat{x}ₜ₋₁.
2. The observation vector zₜ.
3. The observation matrix Hₜ.
4. The observed vector covariance matrix Rₜ.
5. The propagated state \hat{x}_{t|t-1}.
6. The propagation matrix Fₜ.
7. The propagated-state covariance matrix Σ_{t|t-1}.
8. The process noise matrix Qₜ.
9. The overall current state \hat{x}ₜ.
10. The overall current state covariance matrix Σₜ.

Note that three “states” may be referred to: (a) the previous state \hat{x}ₜ₋₁ [symbol] \hat{x}_{t-1|t-1}, (b) its propagated state \hat{x}_{t|t-1}, and (c) the overall current state \hat{x}ₜ [symbol] \hat{x}_{t|t}. The three states may be expressed in form (where c is the speed of light):

$$state = [ \begin{matrix}distance / c \\ distance rate of change / c \\ clock offset \\ clock offset rate\end{matrix} ] \qquad ( 6.1 )$$

The forms differ by the time at which the transceiver generates the state estimates and the information that it uses to generate them. In particular, the transceiver may generate state estimate \hat{x}ₜ₋₁ at time t−1. Then at the current time t the transceiver may generate two state estimates: \hat{x}_{t|t-1} which is the propagation of \hat{x}ₜ₋₁ to time t, not using any information that arrived at time t; and \hat{x}ₜ, which is a combination of the propagated state estimate and new information observed at time t, as provided by the observation vector zₜ.

The Kalman filter variables now will be more fully described.

The Overall Past State \hat{x}ₜ₋₁

The overall past state \hat{x}ₜ₋₁ is the best state estimate the transceiver is able to form at time t−1 having taken into account all information collected up to and including time t−1.

The Observation Vector zₜ and the Observation Matrix Hₜ

At time t, the system has a true state s(t)=[τ(t), τ′(t), θ(t), θ′(t)]^{T} which is unknown to the transceiver, and which is based on τ(t) [symbol] d(t)/c at time t (where d(t) is the distance between the transceivers at time t and c is the speed of light), the clock phase offset θ(t) at time t, and the time derivatives of τ(t) and θ(t). In general, a state may be directly or indirectly observed, or an estimate of the state may be generated, or various linear combinations of the state elements may be observed. The observation vector zₜ is what is ultimately observed, and the observation matrix explains how the observation vector relates to the true state of the system. That is,

$${z}_{l} = {H}_{t} s ( t ) + noise . \qquad ( 6.2 )$$

In a simplified example, if just the delay and the difference between the delay rate and offset rate were observed, the observation matrix may be expressed as:

$${H}_{t} = [ \begin{matrix}1 & 0 & 0 & 0 \\ 0 & 1 & 0 & - 1\end{matrix} ]$$

As provided herein, in some examples the transceiver calculates the observation vector in a manner such as described in the disclosure leading up to Equation 4.6, by indirectly observing all four state elements: delay, offset, the time derivative of the delay, and the time derivative of the offset. The observation matrix, which the transceivers may receive a priori, thus may be expressed as the diagonal matrix:

$${H}_{t} = [ \begin{matrix}1 & 0 & 0 & 0 \\ 0 & 1 & 0 & 0 \\ 0 & 0 & 1 & 0 \\ 0 & 0 & 0 & 1\end{matrix} ] \qquad ( 6.3 )$$

### The Observed State Covariance Matrix Rₜ

The observation vector zₜ is itself an estimate, and as such may be expressed as a random variable with a covariance matrix Rₜ which may be determined as follows. Recall, per the disclosure in Section 4, that one or both of the transceivers generate the observation vector at time t, zₜ by evaluating Equations 3.39-3.41 using the linear fit parameters y_{A}, s_{A}, y_{B}, s_{B} respectively generated by the two transceivers. The transceivers also respectively generate covariance matrices cov(y_{A}, s_{A}) and cov(y_{B}, s_{B}), and optionally share them. One or both of the transceivers compute the joint 4×4 covariance matrix

$$C = [ \begin{matrix}cov ( {y}_{A} , {s}_{A} ) & \\ & cov ( {y}_{B} , {s}_{B} )\end{matrix} ] . \qquad ( 6.4 )$$

The application of Equations 3.39-3.41 is a map of random variables, from

$$\{ {y}_{A} , {s}_{A} , {y}_{B} , {s}_{B} \} \to {z}_{t} = \{ a , b , α , β \} . \qquad ( 6.5 )$$

One or both of the transceivers are configured to calculate the covariance matrix of zₜ by determining the locally linear relationship between {y_{A}, s_{A}, y_{B}, s_{B}} and {a, b, α, β} and applying the usual rule for covariance change under linear transformation. That is, P may express the 4×4 partial derivative matrix as:

$$P = [ \begin{matrix}\frac{\partial a}{\partial {y}_{A}} & \frac{\partial a}{\partial {s}_{A}} & \frac{\partial a}{\partial {y}_{B}} & \frac{\partial a}{\partial {s}_{B}} \\ \frac{\partial b}{\partial {y}_{A}} & \frac{\partial b}{\partial {s}_{A}} & \frac{\partial b}{\partial {y}_{B}} & \frac{\partial b}{\partial {s}_{B}} \\ \frac{\partial α}{\partial {y}_{A}} & \frac{\partial α}{\partial {s}_{A}} & \frac{\partial α}{\partial {y}_{B}} & \frac{\partial α}{\partial {s}_{B}} \\ \frac{\partial β}{\partial {y}_{A}} & \frac{\partial β}{\partial {s}_{A}} & \frac{\partial β}{\partial {y}_{B}} & \frac{\partial β}{\partial {s}_{B}}\end{matrix} ] , \qquad ( 6.6 )$$

then

$$Rt = cov ( {z}_{t} ) = {PCP}^{T} . \qquad ( 6.7 )$$

One or both of the transceivers may be configured to calculate the matrix of partial derivatives P numerically.

The Propagated State \hat{x}_{t|t-1} and the Propagation Matrix Ft

The propagated state \hat{x}_{t|t-1} is the natural propagation of \hat{x}ₜ₋₁ via the transformation

$${F}_{t} = [ \begin{matrix}1 & T & 0 & 0 \\ 0 & 1 & 0 & 0 \\ 0 & 0 & 1 & T \\ 0 & 0 & 0 & 1\end{matrix} ] , \qquad ( 6.8 )$$

where T corresponds to the desired propagation interval, e.g., the duration of one twtt window.
The Propagated-State Covariance Matrix Σ_{t|t-1} and the Process Noise Matrix Qₜ

The transceiver(s) propagate the covariance matrix under the linear transformation Fr by updating covariance matrices under linear transformations, where in some examples, the process noise covariance matrix Qₜ also is added which accounts for the model error induced by the imperfect system dynamics represented by the propagation operation Ft.

$${\sum }_{t \vert t - 1} = cov ( {\hat{x}}_{t \vert t - 1} ) = {F}_{t} {R}_{t} {F}_{t}^{T} + {Q}_{t} . \qquad ( 6.9 )$$

Determining the optimal process noise matrix Qₜ is useful for having the Kalman filter provide the best estimates. The matrix Qₜ is dependent on various parameters, such as system dynamics, and may be suitably adjusted.

The Overall Current State \hat{x}ₜ and the Overall Current State Covariance Matrix Σₜ

In some examples, the transceiver calculates the overall state and its covariance in a manner such as shown in FIG. 8, and forms the final time t state estimate using the propagated previous state and the current observation weighed by the Kalman gain,

$${x}_{t} = {\hat{x}}_{t \vert t - 1} + {K}_{t} ( {z}_{i} - {H}_{i} {\hat{x}}_{t \vert t - 1} ) , \qquad ( 6.1 )$$

$${\sum }_{t} = ( I - {K}_{t} ) {\sum }_{t \vert t - 1} . \qquad ( 6.11 )$$

At each iteration, the Kalman gain also may be updated:

$${K}_{t} = {\sum }_{t \vert t - 1} {( {\sum }_{t \vert t - 1} + {R}_{t} )}^{- 1} . \qquad ( 6.12 )$$

### 7. Communication-Link Based Two-Way Time Transfer and Ranging with Carrier Frequency Offset

In examples described above, transceivers may be configured to use symbol arrival time estimates to generate propagation delay and clock offset estimates. However, communications transceivers also are configured to measure the frequency offset between their local oscillator and the arriving signal's carrier frequency as part of their conversion of the arriving signal to complex baseband, As recognized by the present inventors, this carrier offset, when measured by both transceivers and shared by at least one of the transceivers, offers valuable information that may be leveraged and incorporated into the Kalman filter to further improve estimates of propagation delay and clock offset (and their respective derivatives). This assumes that the symbol timing clock and the local oscillator clock used to generate the carrier are locked.

In this regard, while FIG. 4 illustrates transceiver A 110 as including clock 111 and illustrates transceiver B 120 as including clock 121, the transceivers actually include two clocks. In some examples, clocks 111 and 121 described with reference to FIG. 4 may be symbol clocks relative to which symbol periods are determined. The other clock of each transceiver (not specifically illustrated) is the carrier clock with respect to which the local carrier oscillator is generated. The local carrier oscillator is used both to generate the transmit signal carrier and to down convert arriving signals to complex baseband. In some examples, the symbol clock and the carrier clock of a transceiver may be locked to one another, while in other examples the clocks may not be locked to one another.

In some examples, at some predefined universal time t, such as GMT, A (t) may express the time on transceiver A 110's symbol clock 111 at time t. Similarly, B(t) may express the time on transceiver B 120's symbol clock 121 at time t. The true state at time t may expressed as:

$$s ( t ) = {[ τ ( t ) , {τ}^{′} ( t ) , θ ( t ) , {θ}^{′} ( t ) ]}^{T} , \qquad ( 7.1 )$$

where:
τ(t) [symbol] d(t)/c. Recall that d(t) is the distance in meters between the two transceivers at time t, and c is the speed of light (3×10⁸ m/s).
θ(t)=A(t)−B(t) is the clock offset between the two symbol clocks 111, 121 at time t, where a positive θ(t) corresponds to a lag of clock 121 of transceiver B 120.
   Notice that τ′(t)=d′(t)/c=v(t)/c, where v(t) [symbol] d′(t) and is positive for increasing distance.

The following expressions may be used:
f_{A}(t)=the carrier frequency of transceiver A 110 at time t.
f_{B}(t)=the carrier frequency of transceiver B 120 at time t.
   Note that both f_{A}(t) and f_{B}(t) have a nominal frequency value (which in some examples may be equal to one another), while each of these carrier frequencies may undulate about the nominal frequency.

The following further expressions may be used:
f_{A→B}(t)=the carrier frequency of the signal that transceiver B 120 receives at time t.
f_{B→A}(t)=the carrier frequency of the signal that transceiver A 110 receives at time t.
O_{A}(t)=the frequency offset at time t between the carrier frequency of the signal arriving at transceiver A 110 and transceiver A's local carrier clock frequency.
O_{B}(t)=the frequency offset at time t between the carrier frequency of the signal arriving at transceiver B 120 and transceiver B's local carrier clock frequency.

### That is,

$${O}_{A} {=}^{def} {f}_{B \to A} ( t ) - {f}_{A} ( t ) , \qquad ( 7.2 )$$

$${O}_{B} {=}^{def} {f}_{A \to B} ( t ) - {f}_{B} ( t ) . \qquad ( 7.3 )$$

The contributions to O_{A}(t) and O_{B}(t) may include, may be, or may consist essentially of, Doppler shift and carrier clock rate offset. For example,

$${O}_{A} ( t ) = [ {f}_{B} ( t - τ ( t ) ) - {f}_{A} ( t ) ] - [ \frac{v ( t - τ ( t ) )}{c} {f}_{B} ( t - τ ( t ) ) ] \qquad ( 7.4 )$$

$$= {f}_{B} ( t - τ ( t ) ) [ 1 - \frac{v ( t - τ ( t ) )}{c} ] - {f}_{A} ( t ) , \qquad ( 7.5 )$$

$${O}_{B} ( t ) = [ {f}_{A} ( t - τ ( t ) ) - {f}_{B} ( t ) ] - [ \frac{v ( t - τ ( t ) )}{c} {f}_{A} ( t - τ ( t ) ) ] \qquad ( 7.6 )$$

$$= {f}_{A} ( t - τ ( t ) ) [ 1 - \frac{v ( t - τ ( t ) )}{c} ] - {f}_{B} ( t ) , \qquad ( 7.7 )$$

For both Equations 7.4 and 7.6, the first square bracket is the contribution of carrier rate offset, and the second square bracket is the contribution of Doppler shift.

In some examples, the dynamics of the problem considered are assumed to be sufficiently benign that over a delay interval of τ(t), neither τ′(t) nor the carrier frequencies substantially change. That is, τ′(t−τ(t))≈τ′(t), f_{B}(t−τ(t))≈f_{B}(t), and f_{A}(t−τ(t))≈f_{A}(t). So, from Equations 7.4 and 7.6, and recalling that τ′(t)=v(t)/c,

$${O}_{A} ( t ) \approx [ {f}_{B} ( t ) - {f}_{A} ( t ) ] - {τ}^{′} ( t ) {f}_{B} ( t ) , \qquad ( 7.8 )$$

$${O}_{B} ( t ) \approx [ {f}_{A} ( t ) - {f}_{B} ( t ) ] - {τ}^{′} ( t ) {f}_{A} ( t ) , \qquad ( 7.9 )$$

As recognized by the present inventors, it may be useful to express O_{A}(t) and O_{B}(t) as linear combinations of the state variables τ′(t) and θ′(t). In some examples, the carrier clock and symbol clocks are locked. What this means is that each transceiver generates a carrier that rotates at a pre-determined number of cycles k per transmitted symbol. For transceiver A 110 this corresponds to a frequency (relative to time t) of kRₛA′(t), where Rₛ is the symbol rate and A (t) is the time shown on symbol clock A 111 at time t. That is, the carrier of transceiver A may be expressed as e^{j2π∫}^{^{τ}}^{kRsA′(t)dt}. Similarly, the carrier frequency (relative to time t) of symbol clock B 122 is kRₛB′(t). Note, the symbol rate Rₛ is the symbol rate that each transceiver generates according to its own symbol clock. Accordingly,

$${f}_{A} ( t ) = {kR}_{s} {A}^{′} ( t ) , \qquad ( 7.1 )$$

$${f}_{B} ( t ) = {kR}_{s} {B}^{′} ( t ) . \qquad ( 7.11 )$$

Substituting Equations 7.10 and 7.11 into Equations 7.8 and 7.9, and recalling that the phase offset may be expressed as θ(t)=A(t)−B(t), so that θ′(t)=A′(t)−B′(t), yields the relationships:

$${O}_{A} ( t ) = {kR}_{s} [ - {θ}^{′} ( t ) - {τ}^{′} ( t ) {B}^{′} ( t ) ] , \qquad ( 7.12 )$$

$${O}_{B} ( t ) = {kR}_{s} [ + {θ}^{′} ( t ) - {τ}^{′} ( t ) {A}^{′} ( t ) ] . \qquad ( 7.13 )$$

Note that symbol clocks 111 and 121 do try to follow universal time t, but A (t) and B(t) nonetheless may wiggle mildly around t. That is,

$$A ( t ) = t + {ϵ}_{A} ( t ) , \qquad ( 7.14 )$$

$$B ( t ) = t + {ϵ}_{B} ( t ) . \qquad ( 7.15 )$$

for some relatively small ϵ_{A}(t) and ϵ_{B}(t). Expressed another way,

$${A}^{′} ( t ) = 1 + {ϵ}_{A}^{′} ( t ) , \qquad ( 7.16 )$$

$${B}^{′} ( t ) = 1 + {ϵ}_{B}^{′} ( t ) , \qquad ( 7.17 )$$

where ϵ′_{A}(t) and ϵ′_{B}(t) are the instantaneous frequency offsets of transceiver A 110 and transceiver B 120, respectively. Plugging this into Equations 7.12 and 7.13 yields the expressions:

$${O}_{A} ( t ) = {kR}_{s} [ - {θ}^{′} ( t ) - {τ}^{′} ( t ) {B}^{′} ( t ) ] = - {kR}_{s} [ {θ}^{′} ( t ) + {τ}^{′} ( t ) + {ϵ}_{B}^{′} ( t ) {τ}^{′} ( t ) ] \approx - {kR}_{s} [ {θ}^{′} ( t ) + {τ}^{′} ( t ) ] , \qquad ( 7.18 )$$

$${O}_{B} ( t ) = {kR}_{s} [ + {θ}^{′} ( t ) - {τ}^{′} ( t ) {A}^{′} ( t ) ] = {kR}_{s} [ {θ}^{′} ( t ) - {τ}^{′} ( t ) - {ϵ}_{A}^{′} ( t ) {τ}^{′} ( t ) ] \approx {kR}_{s} [ {θ}^{′} ( t ) - {τ}^{′} ( t ) ] , \qquad ( 7.19 )$$

where the terms ϵ′_{A}(t)τ′(t) and ϵ′_{B}(t)τ′(t) are discarded because in practice, oscillators are highly stable, such that the instantaneous frequency offsets are expected to be much smaller than 1: ϵ′_{A}(t)<<1 and ϵ′_{B}(t)<<1.

In summary, noting that kRₛ=f_{c}, the carrier frequency, the carrier offsets may be expressed as follows:

$${O}_{A} ( t ) \approx - {f}_{c} [ {θ}^{′} ( t ) + {τ}^{′} ( t ) ] , \qquad ( 7.2 )$$

$${O}_{B} ( t ) \approx + {f}_{c} [ {θ}^{′} ( t ) - {τ}^{′} ( t ) ] . \qquad ( 7.21 )$$

In some examples, there are three possible ways the carrier offset measurements may be incorporated into the state estimate, e.g., in a manner as will be described.

As noted above, the state at time t may be expressed as:

$$state ( t ) = [ τ ( t ) , θ ( t ) , {τ}^{′} ( t ) , {θ}^{′} ( t ) ] , \qquad ( 7.22 )$$

where τ(t) [symbol] d(t)/c, θ(t) is the clock offset at time t, d(t) is the range (in meters) between the clocks at time t, and c=3×10⁸ m/s is the speed of light. Further, Equations 3.26 and 3.27 express the linear representation of τ(t) and θ(t) in terms of the parameters a, b, α, β:

$$τ ( t ) = a + bt , \qquad ( 7.23 )$$

$$θ ( t ) = α + β t . \qquad ( 7.24 )$$

Transceiver A 110 and transceiver B 120 each may form two independent estimates of τ′(t) and θ′(t) (or of b and β in terms of the linear representation above):
1. Using symbol timing, using estimates given by Equations 3.39 and 3.40,

$${θ}_{sym}^{′} ( t ) = \frac{- y - \sqrt{{y}^{2} - 4 xz}}{2 x} , \qquad ( 7.25 )$$

$${τ}_{sym}^{′} ( t ) = \frac{( {s}_{A} - β ) {k}_{B}}{1 - β} . \qquad ( 7.26 )$$

2. Using frequency offset, using Equations 7.20 and 7.21,

$${θ}_{fo}^{′} ( t ) = \frac{{O}_{B} ( t ) - {O}_{A} ( t )}{2 {f}_{c}} , \qquad ( 7.27 )$$

$${τ}_{fo}^{′} ( t ) = - \frac{{O}_{A} ( t ) + {O}_{B} ( t )}{2 {f}_{c}} , \qquad ( 7.28 )$$

Note that the carrier offset may provide information about τ′(t) and θ′(t) (and thus about b and β), but may not provide information about τ(t) and θ(t) (and thus about a and α).

In some examples, one or both of transceiver A 110 and transceiver B 120 may incorporate the symbol-based and/or frequency-offset based estimates of θ′(t) and τ′(t) into the overall state estimate in any one of three ways:
1. In examples in which the transceiver is running C-TWTTR without a Kalman filter, the transceiver may be configured to combine the symbol and frequency-offset based estimates in a weighted average according to their variances. In particular, the relationships:

$${σ}_{{θ}_{sym}^{′}}^{2} {=}^{def} var [ {θ}_{sym}^{′} ( t ) ] , \qquad ( 7.29 )$$

$${σ}_{{τ}_{sym}^{′}}^{2} {=}^{def} var [ {τ}_{sym}^{′} ( t ) ] , \qquad ( 7.3 )$$

$${σ}_{{θ}_{fo}^{′}}^{2} {=}^{def} var [ {θ}_{fo}^{′} ( t ) ] , \qquad ( 7.31 )$$

$${σ}_{{τ}_{fo}^{′}}^{2} {=}^{def} var [ {τ}_{fo}^{′} ( t ) ] , \qquad ( 7.32 )$$

may be combined optimally as a weighted average, giving more weight to the lower variance estimate:

$${θ}^{′} ( t ) = [ \frac{{σ}_{{θ}_{fo}^{′}}^{2}}{{σ}_{{θ}_{sym}^{′}}^{2} + {σ}_{{θ}_{fo}^{′}}^{2}} ] {θ}_{sym}^{′} ( t ) + [ \frac{{σ}_{{θ}_{sym}^{′}}^{2}}{{σ}_{{θ}_{sym}^{′}}^{2} + {σ}_{{θ}_{fo}^{′}}^{2}} ] {θ}_{fo}^{′} ( t ) , \qquad ( 7.33 )$$

$${τ}^{′} ( t ) = [ \frac{{σ}_{{τ}_{fo}^{′}}^{2}}{{σ}_{{τ}_{sym}^{′}}^{2} + {σ}_{{τ}_{fo}^{′}}^{2}} ] {τ}_{sym}^{′} ( t ) + [ \frac{{σ}_{{τ}_{sym}^{′}}^{2}}{{σ}_{{τ}_{sym}^{′}}^{2} + {σ}_{{τ}_{fo}^{′}}^{2}} ] {τ}_{fo}^{′} ( t ) . \qquad ( 7.34 )$$

2. In some examples in which the transceiver is running C-TWTTR with a Kalman filter, the transceiver may be configured to combine the estimates as done in Equations 7.33 and 7.34 and then implement a full observability Kalman filter, with measurement matrix:

$${H}_{t} = [ \begin{matrix}1 & 0 & 0 & 0 \\ 0 & 1 & 0 & 0 \\ 0 & 0 & 1 & 0 \\ 0 & 0 & 0 & 1\end{matrix} ] . \qquad ( 7.35 )$$

3. In other examples in which the transceiver is running C-TWTTR with a Kalman filter, the transceiver may be configured to incorporate the carrier offset measurements using a partial-observation Kalman filter. In particular, the transceiver may incorporate the carrier offset measurements O_{A}(t) and O_{B}(t) into the Kalman filter, for example by adding two rows to the measurement matrix Hₜ corresponding to the two linear combinations given by 7.20 and 7.21 for O_{A}(t) and O_{B}(t) in terms of the state elements θ′(t) and τ′(t). That is, after normalizing the carrier offsets by the carrier frequency, the transceiver may implement:

$${H}_{t} = [ \begin{matrix}1 & 0 & 0 & 0 \\ 0 & 1 & 0 & 0 \\ 0 & 0 & 1 & 0 \\ 0 & 0 & 0 & 1 \\ 0 & - 1 & 0 & - 1 \\ 0 & - 1 & 0 & 1\end{matrix} ] . \qquad ( 7.36 )$$

### 8. Global Architecture

In some examples, the C-TWTTR algorithm assumes that the radial and perpendicular velocities of each of the transceivers with respect to one another are available:

$${v}_{A} , {v}_{A}^{⊥} , {v}_{B} , {v}_{B}^{⊥} .$$

However, as explained elsewhere herein, from a practical standpoint C-TWTTR need not necessarily use the perpendicular velocities

$${v}_{A}^{⊥} ( t ) and {v}_{B}^{⊥} ( t ) .$$

Recall Equations 3.2-3.5, repeated here for convenience:

$${v}_{A} ( t ) = the radial velocity of transceiver A 110 away from transceiver B at time t , \qquad ( 8.1 )$$

$${v}_{A}^{⊥} ( t ) = the velocity at time t of transceiver A in the plane perpendicular to radial line connecting A and B , \qquad ( 8.2 )$$

$${v}_{B} ( t ) = the radial velocity of transceiver B away from transceiver A at time t , \qquad ( 8.3 )$$

$${v}_{B}^{⊥} ( t ) = the velocity at time t of transceiver B in the plane perpendicular to radial line connecting A and B . \qquad ( 8.4 )$$

Notice that the C-TWTTR algorithm produces the estimate of the relative velocity between the transceivers v(t) [symbol] d′ (t)=cτ′(t) Note also that v(t)=v_{A}(t)+v_{B}(t). As such, the C-TWTTR algorithm may not by itself provide v_{A}(t) and v_{B}(t) separately (just the sum of these terms). The availability

$$of {v}_{A} ( t ) , {v}_{B} ( t ) , {v}_{A}^{⊥} ( t ) , and {v}_{B}^{⊥} ( t )$$

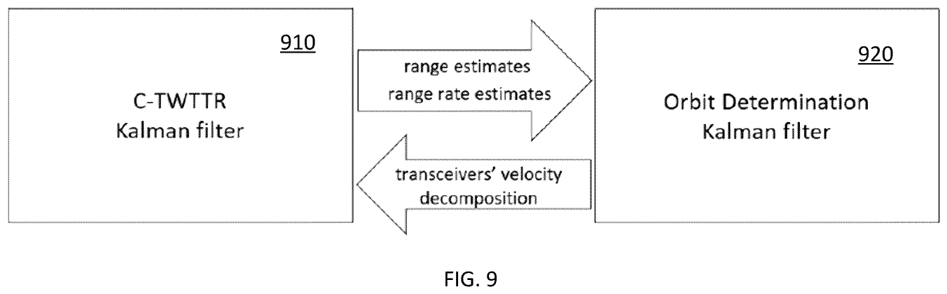

is assumed to be provided from an outside source. For example, for satellite links, the information may be generated by an orbit estimating Kalman filter. The orbit estimation Kalman filter and the C-TWTTR Kalman filter then support one another as shown in FIG. 9, which illustrates example use of two-way time transfer and ranging 910 with an orbit determination Kalman filter 920. The orbit determination Kalman filter 920 of the transceiver ingests range and range rate information from C-TWTTR, and in return may provide C-TWTTR 910 of the transceiver the decomposition of the transceiver velocities-namely,

$${v}_{A} ( t ) , {v}_{B} ( t ) , {v}_{A}^{⊥} ( t ) , {v}_{B}^{⊥} ( t ) .$$

In such fashion, transceiver 110 and/or transceiver 120 may be configured to implement both C-TWTTR and an orbit determination filter that aid one another, working together to provide accurate range, clock offset, their rates, and ephemeris estimates.

### 9. Example Methods

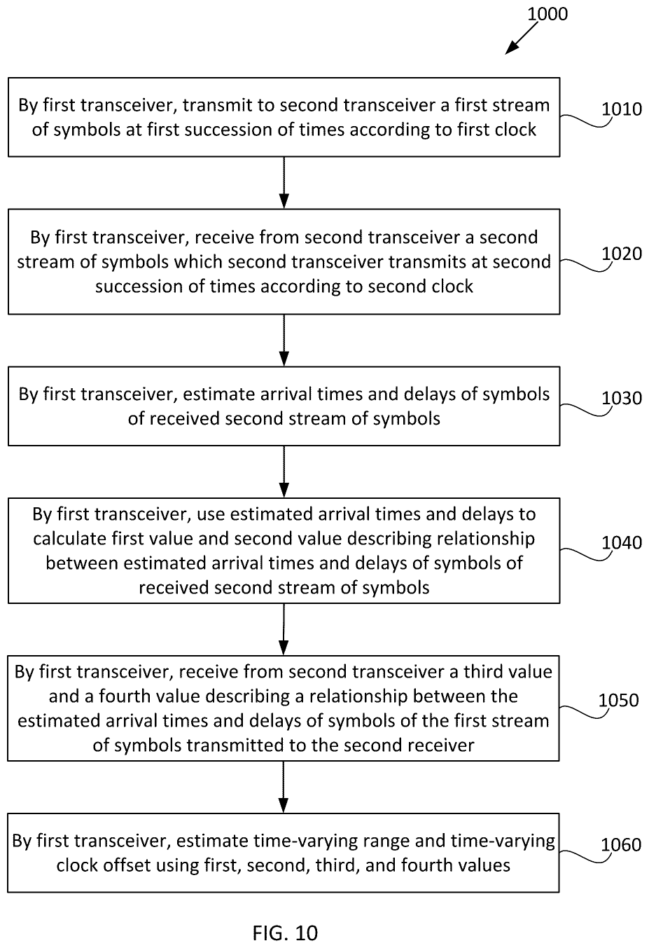

While various example implementations are described above in Sections 1 through 8, it will be appreciated that any suitable changes may be made therein. For example, FIG. 10 illustrates an example flow of operations in a method 1000 for estimating a time-varying range and time-varying clock offset between transceivers, e.g., between a first transceiver having a first clock and a second transceiver having a second clock, wherein the first and second transceivers are moving relative to one another in a manner such as described with reference to FIGS. 2-4. As illustrated in FIG. 10, method 1000 may include, by the first transceiver, transmitting to the second transceiver a first stream of symbols at a first succession of times according to the first clock (operation 1010). For example, in a manner such as described with reference to FIG. 4, first transceiver A 110 may use an antenna of first transceiver A (not specifically illustrated) to transmit a stream of symbols to second transceiver B 120. In some examples, in a manner such as described elsewhere herein, the time on first clock A 111 of first transceiver A may be treated as universal time t. In other examples, the time on first clock A 111 of first transceiver A may be treated as having its own time-varying offset A (t). Second transceiver B 120 may use an antenna of second transceiver B (not specifically illustrated) to receive the first stream of symbols from first transceiver A 110. In some examples, the first transceiver is located on a first satellite or is terrestrial, and the second transceiver is located on a second satellite or is terrestrial. Thus, it will be appreciated that the first and second transceivers may be in any respective location.

Method 1000 illustrated in FIG. 10 further may include, by the first transceiver, receiving from the second transceiver a second stream of symbols which the second transceiver transmits at a second succession of times according to the second clock (operation 1020). For example, in a manner such as described with reference to FIG. 4, second transceiver B 120 may its own antenna to transmit a stream of symbols to first transmitter A 110, and first transmitter A may use its own antenna to receive such signals. In some examples, in a manner such as described elsewhere herein, the time on second clock B 121 of second transceiver B may be treated as having time-varying offset B(t). In other examples, the time on second clock B 121 of second transceiver B 120 may be treated as universal time t. Put another way, the designation of a particular transceiver herein as being the “first” transceiver or the “second” transceiver is arbitrary. In some examples, the first succession of times may include a first symbol at a first known time and a first plurality of additional symbols at a first known symbol rate, and the second succession of times may include a second symbol at a second known time and a second plurality of additional symbols at a second known symbol rate, while in other examples, the first known time and the second known time are a priori known to both the first transceiver and the second transceiver. In either of these cases, the transmission time of the first symbol (according to the clock of the transceiver that generated that symbol) may be implicitly carried by the communication signal, and the transmission times of subsequent symbols in the stream of symbols may be calculated based on the symbol rate. In still other examples, the first stream of signals communicates the first known time to the second transceiver, and the second stream of signals communicates the second known time to the first transceiver; in this case, the transmission time of the first symbol (according to the clock of the transceiver that generated that symbol) may be explicitly carried by the communication signal, and the transmission times of subsequent symbols in the stream of symbols may be calculated based on the symbol rate.

Method 1000 illustrated in FIG. 10 further may include, by the first transceiver, estimating arrival times and delays of symbols of the received second stream of symbols (operation 1030). For example, in a manner such as described with reference to FIGS. 4, 5, and 6A-6B, first transceiver A 110 may be configured to generate a symbol timing estimate and estimated delay for the symbols that second transceiver B 120 transmits thereto. Note that regardless of the particular manner in which the second transceiver B 120 communicates to first transceiver A 110 the transmission time of the second stream of symbols, transceiver A may be configured to calculate delays of the symbols of the second stream by taking the difference (optionally on a per-symbol basis) between the time that transceiver B implicitly or explicitly communicates as being the transmission time of that symbol, and the time that transceiver A actually receives that symbol. Similarly, in a manner such as described with reference to FIGS. 4, 5, and 6A-6B, second transceiver B 120 may be configured to generate a symbol timing estimate and estimated delay for the symbols that first transceiver A 110 transmits thereto. Similarly, regardless of the particular manner in which the first transceiver A 110 communicates to second transceiver B 120 the transmission time of the first stream of symbols, transceiver B may be configured to calculate delays of the symbols of the first stream by taking the difference (optionally on a per-symbol basis) between the time that transceiver A implicitly or explicitly communicates as being the transmission time of that symbol, and the time that transceiver B actually receives that symbol.

Method 1000 illustrated in FIG. 10 further may include, by the first transceiver, using the estimated arrival times and delays to calculate a first value and a second value describing a relationship between the estimated arrival times and delays of symbols of the received second stream of symbols (operation 1040). For example, in a manner such as described with reference to FIGS. 4, 5, and 6A, first transceiver A 110 may be configured to determine the relationship between the estimated arrival times and delays of symbols of the received second stream of symbols by calculating a first best-fit straight line through those estimated delays as a function of those estimated arrival times. Additionally, in a manner such as described with reference to FIGS. 4, 5, and 6B, second transceiver B 120 may be configured to determine the relationship between the estimated arrival times and delays of symbols of the received first stream of symbols by calculating a second best-fit straight line through those estimated delays as a function of the estimated arrival times of symbols transmitted thereto by the first transceiver 110.

Method 1000 illustrated in FIG. 10 further may include, by the first transceiver, receiving from the second transceiver a third value and a fourth value describing the relationship between estimated arrival times and delays of symbols of the first stream of symbols transmitted to the second transceiver (operation 1050). Method 1000 further may include, by the first transceiver, estimating the time-varying range and time-varying clock offset using the first, second, third, and fourth values (operation 1060). Nonlimiting examples of the manner in which the time-varying range and time-varying clock offset are described further above with reference to Equations 3.39-3.42. Optionally, generating the first, second, third, and fourth values may be performed iteratively, e.g., in a manner such as described in Section 5.

While operations 1050 and 1060 of method 1000 may focus on functions implemented using first transceiver A 110, it will be appreciated that similar operations optionally may be implemented using second transceiver B 120. For example, the method optionally further may include, by the first transceiver, transmitting the first value and the second value to the second transceiver. The method optionally further may include, by the second transceiver, transmitting to the first transceiver the second stream of symbols at the second succession of times according to the second clock in a similar manner as described with reference to operation 1010. The method optionally further may include, by the second transceiver, receiving from the first transceiver the first stream of symbols in a similar manner as described with reference to operation 1020. The method optionally further may include, by the second transceiver, estimating arrival times and delays of symbols of the received first stream of symbols in a similar manner as described with reference to operation 1030. The method optionally further may include, by the second transceiver, using the estimated arrival times and delays to calculate the third value and the fourth value in a similar manner as described with reference to operation 1040. The method optionally further may include, by the second transceiver, transmitting to the first transceiver the third value and the fourth value describing a relationship between estimated arrival times and delays of symbols of the first stream of symbols transmitted to the second transceiver in a similar manner as described with reference to operation 1050. The method optionally further may include, by the second transceiver, receiving from the first transceiver the first value and the second value, in a similar manner as described with reference to operation 1050. The method optionally further may include, by the second transceiver, estimating the time-varying range and time-varying clock offset using the first, second, third, and fourth values, in a similar manner as described with reference to operation 1060.

In some examples, the first transceiver further may use a Kalman filter to estimate, or to average an estimate of, at least one of: the time-varying range, time-varying velocity, time-varying clock offset, and time varying clock rate offset. Optionally, the second transceiver further may use a Kalman filter to estimate, or to average an estimate of, at least one of: the time-varying range, time-varying velocity, time-varying clock offset, and time varying clock rate offset. Nonlimiting uses of Kalman filters in such a manner are described elsewhere herein, e.g., in Section 6 and/or Section 8.

In some examples, the first stream of symbols is superimposed on a first carrier and the second stream of symbols is superimposed on a second carrier. In a manner such as described in Section 7, the method further may include, by the first transceiver, estimating at least one of (i) a clock rate offset and (ii) a Doppler shift, using a frequency offset of the first carrier or a frequency offset of the second carrier. Similarly, the method optionally further may include, by the second transceiver, estimating at least one of (i) a clock rate offset and (ii) a Doppler shift, using a frequency offset of the first carrier or a frequency offset of the second carrier.

Note that the transceiver functions described herein may be implemented using any suitable combination of hardware and software. For example, any suitable functionalities of transceivers 110 and/or 120 may be implemented using a suitably programmed field-programmable gate array (FPGA) or application-specific integrated circuit (ASIC). FPGAs and ASICs are commercially available, and methods of programming same to achieve desired logical programming are known in the art. In still other configurations, the functionalities of transceivers 110 and/or 120 may be implemented using a suitably programmed computer, e.g., a suitably programmed general purpose computer including a non-volatile computer-readable medium storing instructions for causing the transceivers to perform such functions.

Illustratively, some examples herein provide a first transceiver which is moving relative to a second transceiver. The first transceiver may include a first clock; an antenna; a processor; and non-volatile computer-readable memory storing operations causing the processor to perform operations. The operations may include transmitting to the second transceiver, via the antenna, a first stream of symbols at a first succession of times according to the first clock (e.g., performing operation 1010 described with reference to FIG. 10). The operations may include receiving from the second transceiver, via the antenna, a second stream of symbols which the second transceiver transmits at a second succession of times according to a second clock of the second transceiver (e.g., performing operation 1020 described with reference to FIG. 10). The operations may include estimating arrival times and delays of symbols of the received second stream of symbols (e.g., performing operation 1030 described with reference to FIG. 10). The operations may include using the estimated arrival times and delays to calculate a first value and a second value describing a relationship between the estimated arrival times and delays of symbols of the received second stream of symbols (e.g., performing operation 1040 described with reference to FIG. 10). The operations may include receiving from the second transceiver, via the antenna, a third value and a fourth value describing a relationship between estimated arrival times and delays of symbols of the first stream of symbols transmitted to the second transceiver (e.g., performing operation 1050 described with reference to FIG. 10). The operations may include estimating the time-varying range and time-varying clock offset using the first, second, third, and fourth values (e.g., performing operation 1060 described with reference to FIG. 10). The second transceiver may be similarly configured as the first transceiver e.g., to perform at least the analogs of operations 1010, 1020, 1030, and 1040 and to transmit the third and fourth value to the first transceiver, and optionally to also perform the analogs of operations 1050 and 1060. However, it will be appreciated that the first and second transceivers also can be configured differently than one another. Moreover, the first and second transceivers need not be controlled or owned by the same entity as one another.

Some examples herein provide a system that includes both the first transceiver and the second transceiver. Such a system may include a first transceiver including a first clock and a first antenna; and a second transceiver including a second clock and a second antenna. In a manner such as described elsewhere herein, the first transceiver and the second transceiver may be moving relative to one another. The first transceiver may be configured to transmit to the second transceiver, via the first antenna, a first stream of symbols at a first succession of times according to the first clock. The second transceiver may be configured to transmit to the first transceiver, via the second antenna, a second stream of symbols at a second succession of times according to the second clock. The first transceiver may be configured to: receive the second stream of symbols from the second transceiver, via the first antenna; estimate arrival times and delays of symbols of the received second stream of symbols; and use the estimated arrival times and delays to calculate a first value and a second value describing a relationship between the estimated arrival times and delays of symbols of the received second stream of symbols. The second transceiver may be configured to: receive the first stream of symbols from the first transceiver, via the second antenna; estimate arrival times and delays of symbols of the received first stream of symbols; use the estimated arrival times and delays to calculate a third value and a fourth value describing a relationship between the estimated arrival times and delays of symbols of the received first stream of symbols; and transmit the third value and the fourth value to the first transceiver, via the second antenna. The first transceiver may be configured to: receive from the second transceiver, via the antenna, the third value and the fourth value; and estimate a time-varying range and a time-varying clock offset between the first transceiver and the second transceiver using the first, second, third, and fourth values. Optionally, in some examples, the first transceiver is configured to transmit the first value and the second value to the second transceiver, via the first antenna. Optionally, in some examples, the second transceiver is configured to estimate the time-varying range and the time-varying clock offset between the first transceiver and the second transceiver using the first, second, third, and fourth values. In other examples, the second transceiver does not calculate the time-varying range and/or the time-varying clock offset.

### Working Example

The following example is intended to be purely illustrative, and not limiting of the present subject matter.

CTWTTR performance was obtained for an example of two medium earth orbit (MEO) satellites coming from a GPS satellite simulation. A two minute time interval was chosen during which cross range acceleration was maximal. Illustratively, a V-band cross link with a carrier frequency in the neighborhood of 62.1 GHz was used in the simulation run. Clock offset was set initially to 1 second, with an offset rate of 10⁻⁷ s/s and offset acceleration of 10⁻¹⁰ s/s².

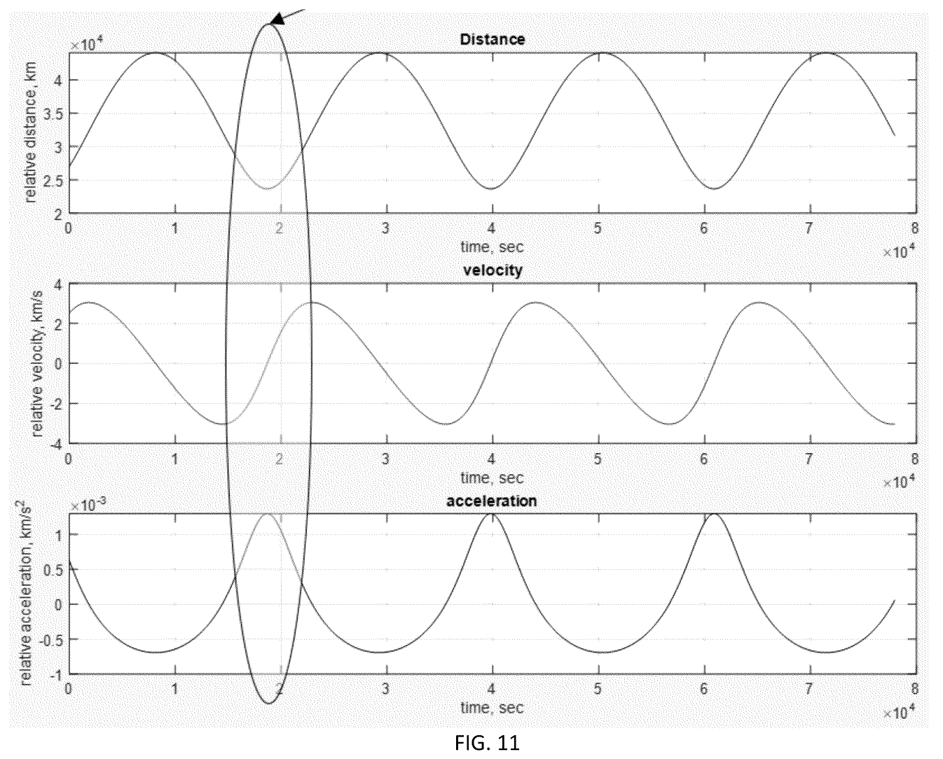

FIG. 11 illustrates orbit information for the simulated medium earth orbit (MEO) scenario. C-TWTTR was used for models of both a coherent and noncoherent receiver. The separation between the two MEO satellites was modeled to be approximately 25,000 km; the relative velocity of the two MEO satellites was modeled to be approximately 2,000 m/s; and the relative acceleration of the two MEO satellites was approximately 1 m/s². Additionally, the two MEO satellites were modeled to be on distinct, non-adjacent orbit planes. FIG. 12 illustrates the relative distance between the satellites as a function of time; the relative velocity between the satellites as a function of time, and the relative acceleration between the satellites a function of time. C-TWTTR was implemented using the Kalman filter architecture, for receiver designs with and without frequency offset estimation. In particular, for the case where a frequency offset estimate is provided by the receiver, C-TWTTR was implemented as described in Section 7, with frequency offset measurements incorporated as described in paragraph 0139. For the case where a frequency offset estimate is unavailable, where frequency offset information is presumed unavailable, C-TWTTR was architecture as described in Sections 3 and 4. As can be seen, millimeter range and pico-second level clock offset estimates are achievable.

| | | | | |
|---|---|---|---|---|
| | Distance | Velocity | Offset | Offset |
| R_{sym} | error | error | error | rate error |
| (MSym/s) | (cm) | (m/s) | (ps) | (s/s) |

MEO Orbits, With Frequency Offset Estimates

| | | | | |
|---|---|---|---|---|
| 2.56 | 4 | 0.2 | 120 | 5.8 × 10⁻¹¹ |
| 70 | 0.3 | 0.04 | 8 | 7 × 10⁻¹¹ |
| 300 | 0.2 | 0.03 | 2 | 4.0 × 10⁻¹¹ |
| 1000 | 0.2 | 0.03 | 0.9 | 1.6 × 10⁻¹¹ |

MEO Orbits, Without Frequency Offset Estimates

| | | | | |
|---|---|---|---|---|
| 2.56 | 15 | 1.6 | 300 | 6.5 × 10⁻⁹ |
| 70 | 0.6 | 0.06 | 10 | 2.1 × 10⁻¹⁰ |
| 300 | 0.3 | 0.03 | 2.5 | 5.2 × 10⁻¹¹ |
| 1000 | 0.3 | 0.3 | 0.9 | 1.5 × 10⁻¹¹ |

The optimal process noise matrix added by the Kalman filter has significant effect on performance. System dynamics, available observations, noise level, twtt window length, all have nontrivial effects on the optimal process noise choice. The communication link is assumed to be closed. A symbol timing error of a tenth of a symbol period, at all symbol rates, is believed to be a reasonable assumption for a closed link.

Regarding the choice of standard deviation for the frequency offset error labeled below as σ_{FO}, a transceiver may convert the received signal to complex baseband in two steps, which may be referred to as 1 and step 2. Step 1 occurs prior to the match filter. In step 1 the receiver's goal is to down-convert the signal to within 10% of the bandwidth of the signal. This ensures that the match filter does not irretrievably distort the signal. Writing s (t) for the transmitted signal, the output of the match filter then may be expressed as:

$$r ( t ) = s ( t ) {e}^{j ω t}$$

for some small leftover frequency ω. The transceiver samples the signal at 1 sample per symbol. But the residual carrier e^{jωt} causes the symbols to smear cyclically. The transceiver searches for the frequency Ω such that the samples of r(f)e^{-jΩt} do not smear cyclically. If the transceiver processes an interval of length T seconds, then the symbols may smear a total angle of (ω−Ω) T radians. How accurately can the transceiver determine Ω? At a given signal to noise ratio (SNR), the symbol estimates form a cloud around the true transmitted symbols, whose magnitude is measured by the Error Vector Magnitude (EVM). Assume that a given SNR being considered produces symbol clouds with generic angular radius θ radians. Then the smallest the residual frequency error ω−Ω can be is such that (ω−Ω)T>θ. Or,

$$residual frequency error = ω - Ω > \frac{θ}{T} .$$

For example, for θ=π/4≈0.8, the standard deviation of the residual frequency offset may be on the order of 0.8/T. For computational simplicity, it may be assumed that the residual frequency offset is approximately 1/THz. Note that T=Nₛ/Rₛ, where Nₛ is the number of symbols processed and Rₛ is the symbols rate. So the residual frequency offset may have standard deviation on the order of 1/T=Rₛ/Nₛ Hz. In one example, the C-TWTTR window has duration 0.1 seconds, so the frequency offset residual in this example may be on the order of σ_{FO}=1/0.1=10 Hz, the frequency offset that is used in the simulation runs.

As stated above, it can be seen from the C-TWTTR results above, highly accurate millimeter range and pico-second level clock offset estimates are achievable for dynamic links.

### Additional Examples

While various illustrative embodiments of the invention are described above, it will be apparent to one skilled in the art that various changes and modifications can be made therein without departing from the invention. For example, it will be appreciated that the time-varying clock offset suitably may be used to synchronize the first clock to the second clock and/or to synchronize the second clock to the first clock. The appended claims are intended to cover all such changes and modifications that fall within the true spirit and scope of the invention.

Real world examples that require two-way time transfer and ranging for dynamic environments, thereby requiring range, offset, and their derivatives to be estimated, are two satellites with varying range among them, such as two GPS receivers, a satellite and a ground station whereby the range among the two varies with time, or flying drones with a need to synchronize their clocks and determine their varying range.

What is claimed is:

1. A method for estimating a time-varying range and time-varying clock offset between a first transceiver having a first clock and a second transceiver having a second clock, wherein the first and second transceivers are moving relative to one another, the method comprising:
by the first transceiver, transmitting to the second transceiver a first stream of symbols at a first succession of times according to the first clock;
by the first transceiver, receiving from the second transceiver a second stream of symbols which the second transceiver transmits at a second succession of times according to the second clock;
by the first transceiver, estimating arrival times and delays of symbols of the received second stream of symbols;
by the first transceiver, using the estimated arrival times and delays to calculate a first value and a second value describing a relationship between the estimated arrival times and delays of symbols of the received second stream of symbols;
by the first transceiver, receiving from the second transceiver a third value and a fourth value describing a relationship between estimated arrival times and delays of symbols of the first stream of symbols transmitted to the second transceiver; and
by the first transceiver, estimating the time-varying range and time-varying clock offset using the first, second, third, and fourth values.

2. The method of claim 1, wherein the first succession of times comprises a first symbol at a first known time and a first plurality of additional symbols at a first known symbol rate, and the second succession of times comprises a second symbol at a second known time and a second plurality of additional symbols at a second known symbol rate.

3. The method of claim 1, wherein the first known time and the second known time are a priori known to both the first transceiver and the second transceiver.

4. The method of claim 1, wherein the first stream of signals communicates the first known time to the second transceiver, and wherein the second stream of signals communicates the second known time to the first transceiver.

5. The method of claim 1, wherein the relationship between the estimated arrival times and delays of symbols of the received second stream of symbols comprises a first best-fit straight line through those estimated delays as a function of those estimated arrival times.

6. The method of claim 5, wherein the first value comprises a slope (s_{A}) of the first best-fit straight line, and wherein the second value comprises a y-intercept (y_{A}) of the first best-fit straight line.

7. The method of claim 6, wherein the relationship between the estimated arrival times and delays of symbols of the first stream of symbols transmitted to the second transceiver comprises a second best-fit straight line through those estimated delays as a function of those estimated arrival times.

8. The method of claim 7, wherein the third value comprises a slope (s_{B}) of the second best-fit straight line, and wherein the fourth value comprises a y-intercept (y_{B}) of the second best-fit straight line.

9. The method of claim 8, wherein the first transceiver estimates the time-varying range and clock offset using:
$$β = \frac{- y - \sqrt{{y}^{2} - 4 xz}}{2 x} ,$$
$$b = \frac{( {s}_{A} - β ) {k}_{B}}{1 - β} ,$$
$$a = \frac{{y}_{B} - {y}_{A} \frac{( b / {k}_{A} ) - 1}{1 - β}}{\frac{1}{{k}_{A}} - \frac{( b / {k}_{A} ) - 1}{{k}_{B}}} ,$$
$$α = {y}_{A} - \frac{a ( 1 - β )}{{k}_{B}} ,$$
wherein:
c is the speed of light;
k_{A} and k_{B} are constants;
α is the time-varying clock offset;
β is a rate of change of the time-varying clock offset;
ca is the estimated time-varying range;
cb is the estimated time-varying velocity; and
$$x {=}^{def} 1 - {s}_{B} ,$$
$$z {=}^{def} {k}_{A} {s}_{B} - {k}_{B} - ( 1 - {s}_{B} ) {k}_{A} ,$$
$$z {=}^{def} {s}_{A} {k}_{B} - {k}_{A} {s}_{B} .$$

10. The method of claim 1, further comprising, by the first transceiver, transmitting the first value and the second value to the second transceiver.

11. The method of claim 10, further comprising:
by the second transceiver, transmitting to the first transceiver the second stream of symbols at the second succession of times according to the second clock;
by the second transceiver, receiving from the first transceiver the first stream of symbols;
by the second transceiver, estimating arrival times and delays of symbols of the received first stream of symbols;
by the second transceiver, using the estimated arrival times and delays to calculate the third value and the fourth value;
by the second transceiver, transmitting to the first transceiver the third value and the fourth value describing a relationship between estimated arrival times and delays of symbols of the first stream of symbols transmitted to the second transceiver;
by the second transceiver, receiving from the first transceiver the first value and the second value; and
by the second transceiver, estimating the time-varying range and time-varying clock offset using the first, second, third, and fourth values.

12. The method of claim 1, wherein the first transceiver further uses a Kalman filter to estimate, or to average an estimate of, at least one of: the time-varying range, time-varying velocity, time-varying clock offset, and time varying clock rate offset.

13. The method of claim 1, wherein the first transceiver is located on a first satellite or is terrestrial, and wherein the second transceiver is located on a second satellite or is terrestrial.

14. The method of claim 1, further comprising using the time-varying clock offset to synchronize the first clock to the second clock.

15. The method of claim 1, wherein the first stream of symbols is superimposed on a first carrier, the second stream of symbols is superimposed on a second carrier, the method further comprising, by the first transceiver, estimating at least one of (i) a clock rate offset and (ii) a Doppler shift, using a frequency offset of the first carrier or a frequency offset of the second carrier.

16. The method of claim 1, wherein generating the first, second, third, and fourth values is performed iteratively.

17. A first transceiver which is moving relative to a second transceiver, the first transceiver comprising:
a first clock;
an antenna;
a processor; and
non-volatile computer-readable memory storing operations causing the processor to:
transmit to the second transceiver, via the antenna, a first stream of symbols at a first succession of times according to the first clock;
receiving from the second transceiver, via the antenna, a second stream of symbols which the second transceiver transmits at a second succession of times according to a second clock of the second transceiver;
estimate arrival times and delays of symbols of the received second stream of symbols;
use the estimated arrival times and delays to calculate a first value and a second value describing a relationship between the estimated arrival times and delays of symbols of the received second stream of symbols;
receive from the second transceiver, via the antenna, a third value and a fourth value describing a relationship between estimated arrival times and delays of symbols of the first stream of symbols transmitted to the second transceiver; and
estimate the time-varying range and time-varying clock offset using the first, second, third, and fourth values.

18. A system comprising:
a first transceiver comprising a first clock and a first antenna; and
a second transceiver comprising a second clock and a second antenna, wherein:
the first transceiver and the second transceiver are moving relative to one another;
the first transceiver is configured to transmit to the second transceiver, via the first antenna, a first stream of symbols at a first succession of times according to the first clock;
the second transceiver is configured to transmit to the first transceiver, via the second antenna, a second stream of symbols at a second succession of times according to the second clock;
the first transceiver is configured to:
receive the second stream of symbols from the second transceiver, via the first antenna;
estimate arrival times and delays of symbols of the received second stream of symbols; and
use the estimated arrival times and delays to calculate a first value and a second value describing a relationship between the estimated arrival times and delays of symbols of the received second stream of symbols;
the second transceiver is configured to:
receive the first stream of symbols from the first transceiver, via the second antenna;
estimate arrival times and delays of symbols of the received first stream of symbols;
use the estimated arrival times and delays to calculate a third value and a fourth value describing a relationship between the estimated arrival times and delays of symbols of the received first stream of symbols; and
transmit the third value and the fourth value to the first transceiver, via the second antenna; and
the first transceiver is configured to:
receive from the second transceiver, via the antenna, the third value and the fourth value; and
estimate a time-varying range and a time-varying clock offset between the first transceiver and the second transceiver using the first, second, third, and fourth values.

19. The system according to claim 18, wherein the first transceiver is configured to transmit the first value and the second value to the second transceiver, via the first antenna.

20. The system according to claim 19, wherein the second transceiver is configured to estimate the time-varying range and the time-varying clock offset between the first transceiver and the second transceiver using the first, second, third, and fourth values.
